(19) United States
(12) Patent Application Publication
(10) Pub. No.: US 2005/0057175 A1
(43) Pub. Date: Mar. 17, 2005

(54) Display and method of driving display

(75) Inventors: Yukihisa Takeuchi, Nishikamo-Gun (JP); Tsutomu Nanataki, Toyoake-City (JP); Iwao Ohwada, Nagoya-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/919,678

(22) Filed: Aug. 16, 2004

(30) Foreign Application Priority Data
Aug. 22, 2003 (JP) 2003-299204

(51) Int. Cl. G09G 3/10

(52) U.S. Cl. 315/169.3

(57) ABSTRACT

A drive circuit has a drive voltage generating circuit for generating a drive voltage, to be applied between a first electrode and a second electrode of a corresponding electron emitter, based on a selection signal from a corresponding selection line. The drive circuit further includes a modulation circuit for stepwise modulating the amplitude of a drive pulse based on a pixel signal from a corresponding signal line, for thereby controlling the luminance gradation of a corresponding pixel, wherein the drive voltage has a waveform including a drive pulse appearing in timed relation to a selection instruction from the selection line, and wherein the drive pulse, having a predetermined amplitude level, is applied between the first electrode and the second electrode, to cause at least part of an emitter to invert or change the polarization thereof to emit electrons from the electron emitter.

### BACKGROUND OF THE INVENTION

1. Field of the Invention

The present invention relates to a display comprising electron emitters each having a cathode electrode and an anode electrode that are disposed in an emitter, and a method of driving the display.

2. Description of the Related Art

Recently, electron emitters having a drive electrode and a common electrode have been finding use in various applications such as field emission displays (FEDs) and backlight units. In an FED, a plurality of electron emitters are arranged in a two-dimensional array, and a plurality of phosphors are positioned in association with the respective electron emitters with a predetermined gap left therebetween.

Conventional electron emitters are disclosed in Japanese Laid-Open Patent Publication No. 1-311533, Japanese Laid-Open Patent Publication No. 7-147131, Japanese Laid-Open Patent Publication No. 2000-285801, Japanese Patent Publication No. 46-20944, and Japanese Patent Publication No. 44-26125, for example. All of these disclosed electron emitters are disadvantageous in that, since no dielectric body is employed in the emitter, a forming process or a micromachining process is required between facing electrodes, a high voltage needs to be applied to emit electrons, and the panel fabrication process is complex and entails a high panel fabrication cost.

It has been considered to make an emitter from a dielectric material. However, various theories about the emission of electrons from dielectric materials have been presented in the following documents: Yasuoka and Ishii, “Pulse Electron Source Using a Ferrodielectric Cathode,” J. Appl. Phys., Vol. 68, No. 5, pp. 546-550 (1999), and V. F. Puchkarev, G. A. Mesyats, “On the Mechanism of Emission from the Ferroelectric Ceramic Cathode,” J. Appl. Phys., Vol. 78, No. 9, 1 November, 1995, pp. 5633-5637.

Most conventional displays employing electron emitters operate according to a digital control process for selectively emitting or not emitting electrons, and are unable to perform fine gradation control as they lack the concept of an analog control process for controlling the quantity of electrons to be emitted from the emitter.

### SUMMARY OF THE INVENTION

It is therefore an object of the present invention to provide a display which is capable of performing an analog control process for controlling the quantity of electrons to be emitted from electron emitters to realize fine gradation control, and a method of driving such a display.

According to the present invention, there is provided a display comprising a plurality of electron emitters arrayed in association with respective pixels, at least one selection line for supplying an instruction to select or not select each of the electron emitters, at least one signal line for supplying a pixel signal to a selected one of the electron emitters, and a drive section having a plurality of drive circuits arrayed in association with the electron emitters, respectively, for driving the electron emitters based on an instruction from one of the at least one selection line and the pixel signal from one of the at least one signal line, each of the electron emitters comprising an emitter made of a dielectric material, and a first electrode and a second electrode mounted on the emitter, each of the drive circuits comprising a drive voltage generating circuit for generating a drive voltage to be applied between the first electrode and the second electrode of a corresponding one of the electron emitters based on the instruction from a corresponding one of the at least one selection line, and a modulation circuit for modulating the amplitude of a drive pulse stepwise based on the pixel signal from a corresponding one of the at least one signal line, for thereby controlling the luminance gradation of a corresponding pixel if the drive voltage has a waveform including the drive pulse appearing in timed relation to the instruction from the selection line, and wherein a drive pulse having a predetermined amplitude level is applied between the first electrode and the second electrode to cause at least part of the emitter to invert or change the polarization thereof to emit electrons from the electron emitter.

According to the present invention, there is also provided a method of driving the above display, comprising the steps of generating a drive voltage to be applied between the first electrode and the second electrode of a corresponding one of the electron emitters based on an instruction from a corresponding one of the at least one selection line, and modulating the amplitude of a drive pulse stepwise based on the pixel signal from a corresponding one of the at least one signal line, for thereby controlling the luminance gradation of a corresponding pixel if the drive voltage has a waveform including the drive pulse appearing in timed relation to the instruction from the selection line, and wherein a drive pulse having a predetermined amplitude level is applied between the first electrode and the second electrode to cause at least part of the emitter to invert or change the polarization thereof to emit electrons from the electron emitter.

The display may further comprise a collector electrode disposed in facing relation to the electron emitters, and a plurality of fluorescent layers spaced from the electron emitters by respective intervals.

When a certain pixel is selected via the selection line, a drive pulse is applied between the first electrode and the second electrode of the electron emitter corresponding to the selected pixel. If a pixel signal supplied from the signal line to the electron emitter represents the emission of light (ON), then a drive pulse having a predetermined amplitude level is applied to the electron emitter. The polarization of at least part of the emitter is inverted to emit electrons from the electron emitter. Since the amplitude of the drive pulse is modulated stepwise based on the pixel signal from the signal line, the amount of electrons emitted from at least the electron emitter is controlled. That is, the luminance gradation of the pixel corresponding to the electron emitter is modulated in an analog fashion depending on the pixel signal.

With the display according to the present invention, therefore, the amount of electrons emitted from the electron emitter can be controlled in an analog fashion for fine gradation control.

The first electrode may have a potential lower than the potential of the second electrode during a period in which the drive pulse is applied. In this case, the first electrode functions as a cathode while the second electrode functions as an anode, and electrons are emitted from the emitter nearest to the first electrode.

The drive voltage has a waveform including a drive pulse having a first amplitude which is not sufficient enough to emit electrons from the electron emitter in timed relation to the instruction from the selection line, and the amplitude of the drive pulse is maintained at the first amplitude if the pixel signal is a signal representing the extinguishing of light, and the amplitude of the drive pulse is set to a second amplitude which is sufficient enough to emit electrons from the electron emitter, and the pulse duration of the second amplitude is modulated based on a gradation component included in the pixel signal if the pixel signal is a signal representing the emission of light.

Alternatively, the amplitude of the drive pulse is modulated into a first amplitude which is not sufficient enough to emit electrons from the electron emitter if the pixel signal is a signal representing the extinguishing of light, and the amplitude of the drive pulse is set to a second amplitude which is sufficient enough to emit electrons from the electron emitter and the pulse duration of the second amplitude is modulated based on a gradation component included in the pixel signal if the pixel signal is a signal representing the emission of light.

With the amplitude being thus modulated, the amount of electrons emitted from the electron emitter can be controlled in an analog fashion for fine gradation control.

The following relationship is preferably satisfied:
τd=τ1+τ2
|V2|>|V1|
where τd represents the pulse duration of the drive pulse, V1 is the first amplitude of the drive pulse, V2 is the second amplitude of the drive pulse, τ1 is the pulse duration of the first amplitude, and τ2 is the pulse duration of the second amplitude.

The emitter (34) may be made of a piezoelectric material or an electrostrictive material, and if the period of one frame includes a selection period and a non-selection period, then at least one drive pulse may be applied between the first electrode and the second electrode during the selection period, and a voltage such that the first electrode has a potential higher than the potential of the second electrode may be applied between the first electrode and the second electrode during the non-selection period.

The emitter is polarized by an electric field in a direction such that the potential of the first electrode is lower than the potential of the second electrode during the selection period, and the emitter is polarized by an electric field in another direction such that the potential of the second electrode is lower than the potential of the first electrode during the non-selection period.

Specifically, during the non-selection period, a voltage such that the potential of the first electrode is higher than the potential of the second electrode is applied to polarize part of the emitter in one direction. In the next selection period, a drive pulse is applied to the electron emitter. If the pixel signal is a signal representing the emission of light at this time, then the polarization of part of the emitter is changed to the extent that electrons are emitted therefrom. Electrons are now emitted from the electron emitter, with the result that the pixel corresponding to the electron emitter is turned on. If the pixel signal is a signal representing the extinguishing of light, then the polarization of part of the emitter is changed to the extent that no electrons are emitted therefrom. Therefore, no electrons are emitted from the electron emitter, with the result that the pixel corresponding to the electron emitter is turned off.

Subsequently, when the non-selection period begins again, a voltage is applied such that the potential of the first electrode is higher than the potential of the second electrode, to thereby polarize the same part of the emitter in one direction again. Therefore, the non-selection period may be defined as a preparatory period for preparing the emitter to emit electrons in a next selection period.

The emitter may be made of an electrostrictive material, and if the drive voltage is output during a period including a selection period and a non-selection period, then a reset voltage, in which the first electrode has a potential higher than the potential of the second electrode, may be applied between the first electrode and the second electrode immediately before the selection period, at least one drive pulse may be applied between the first electrode and the second electrode during the selection period, and an arbitrary voltage between at least the reset voltage and the voltage of the drive pulse may be applied between the first electrode and the second electrode during the non-selection period, wherein the selection period may be started after the reset voltage is applied.

The emitter is thus polarized by an electric field in a direction such that the potential of the first electrode is higher than the potential of the second electrode under the reset voltage.

Specifically, during the non-selection period, a reset voltage, in which the potential of the first electrode is higher than the potential of the second electrode, is applied to polarize part of the emitter in one direction. In the next selection period, a drive pulse is applied to the electron emitter. If the pixel signal is a signal representing the emission of light at this time, then the polarization of part of the emitter is changed to the extent that electrons are emitted therefrom. Electrons are now emitted from the electron emitter, with the result that the pixel corresponding to the electron emitter is turned on. If the pixel signal is a signal representing the extinguishing of light, then the polarization of part of the emitter is changed to the extent that no electrons are emitted therefrom. Therefore, no electrons are emitted from the electron emitter, with the result that the pixel corresponding to the electron emitter is turned off.

Subsequently, when the non-selection period begins again, an arbitrary voltage is applied that is between the reset voltage and the voltage of the drive pulse. Since the voltage is not a sharp voltage change immediately after the reset voltage, no electrons are emitted from the electron emitter. Specifically, within the selection period, and if the pixel signal is a signal representing the emission of light, since the emitter is sufficiently polarized in one direction immediately prior to the selection period, electrons are emitted when the selection period begins. However, even if the above arbitrary voltage is applied during the non-selection period after elapse of the selection period, because part of the emitter has not been sufficiently polarized in one direction, no electrons are emitted.

During the non-selection period immediately prior to the selection period, the reset voltage is applied to polarize part of the emitter again in one direction. Therefore, the period in which the reset voltage is applied may be defined as a preparatory period for preparing the emitter to emit electrons in a next selection period.

With the display and the method of driving the display according to the present invention, as described above, the amount of electrons emitted from the electron emitter can be controlled in an analog fashion for fine gradation control.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a fragmentary cross-sectional view, partly in block form, of a display according to a first embodiment of the present invention;

FIG. 2 is a block diagram of a circuit arrangement of the display according to the first embodiment of the present invention;

FIG. 3A is a plan view of electrodes of an electron emitter;

FIG. 3B is a plan view of electrodes according to a first modification;

FIG. 4 is a plan view of electrodes according to a second modification;

FIG. 5 is a waveform diagram showing a drive voltage output from a pulse generation source;

FIG. 6 is a fragmentary cross-sectional view illustrative of the manner in which a first voltage is applied between a cathode electrode and an anode electrode;

FIG. 7 is a fragmentary cross-sectional view illustrative of an electron emission when a second voltage is applied between the cathode electrode and the anode electrode;

FIG. 8 is a fragmentary cross-sectional view illustrating self-inactivation of an electron emission due to a negative charge on the surface of an emitter;

FIG. 9 is a characteristic diagram showing the relationship between the energy of emitted secondary electrons and the quantity of emitted secondary electrons;

FIG. 10A is a waveform diagram of a drive voltage;

FIG. 10B is a waveform diagram showing a change in voltage between the anode electrode and the cathode electrode of the electron emitter according to the first embodiment;

FIG. 11 is a fragmentary cross-sectional view, partly in block form, of a first modification of the display according to the first embodiment of the present invention;

FIG. 12 is a block diagram of a drive circuit;

FIG. 13A is a waveform diagram showing a selection signal;

FIG. 13B is a waveform diagram showing a pixel signal;

FIG. 13C is a waveform diagram showing a drive voltage generated by a first modulation process;

FIG. 13D is a waveform diagram showing the drive voltage, which has been modulated by a first modulation process;

FIG. 14A is a waveform diagram showing a selection signal;

FIG. 14B is a waveform diagram showing a pixel signal;

FIG. 14C is a waveform diagram showing a drive voltage generated by a second modulation process;

FIG. 14D is a waveform diagram showing the drive voltage, which has been modulated by a second modulation process;

FIG. 15 is a characteristic diagram showing the relationship between a collector voltage and luminance;

FIG. 16 is a characteristic diagram showing the relationship between a voltage Va2, applied between the cathode electrode and the anode electrode, and luminance;

FIG. 17 is a characteristic diagram showing the relationship between a voltage Va1, applied between the cathode electrode and the anode electrode, and luminance;

FIG. 18 is a characteristic diagram showing the relationship between the pulse duration at a second amplitude of a drive pulse and luminance;

FIG. 19 is a circuit diagram, partly in block form, showing a conceptual representation of a drive circuit according to a preferred embodiment of the present invention;

FIG. 20 is a waveform diagram illustrating the manner in which the drive circuit operates, particularly when a pixel signal is a signal representing the extinguishing of light;

FIG. 21 is a waveform diagram illustrating the manner in which the drive circuit operates, particularly when a pixel signal is a signal representing the emission of light;

FIG. 22 is a circuit diagram showing a drive circuit according to a specific example;

FIG. 23 is a perspective view of a sample (display) used in an experimental example;

FIG. 24A is a waveform diagram showing a selection signal;

FIG. 24B is a waveform diagram showing a pixel signal;

FIG. 24C is a waveform diagram showing a drive voltage caused due to electric power retrieval;

FIG. 25 is a diagram showing the polarization vs. electric field characteristic of a piezoelectric material;

FIG. 26 is a waveform diagram illustrative of a first drive process;

FIG. 27 is a diagram showing the polarization vs. electric field characteristic of an electrostrictive material;

FIG. 28 is a waveform diagram illustrative of a second drive process;

FIG. 29 is a view, partly in block form, of a second modification of the display according to the first embodiment of the present invention;

FIG. 30 is a cross-sectional view of an electron emitter of the second modification of the display according to the first embodiment of the present invention;

FIG. 31 is a circuit diagram showing an equivalent circuit of the electron emitter shown in FIG. 30, wherein a current primarily flows between the cathode electrode and the collector electrode;

FIG. 32 is a diagram showing the output characteristics (Vkc-Ikc characteristics) of the electron emitter shown in FIG. 30;

FIG. 33 is a circuit diagram showing an equivalent circuit of an arrangement in which a control electrode is disposed between the cathode electrode and the collector electrode, wherein a collector current flows through the collector electrode and a control current flows through the control electrode;

FIG. 34 is a fragmentary cross-sectional view of a display according to a second embodiment of the present invention;

FIG. 35 is a fragmentary cross-sectional view of a display according to a third embodiment of the present invention;

FIG. 36 is a fragmentary cross-sectional view of a display according to a fourth embodiment of the present invention;

FIG. 37 is a fragmentary cross-sectional view of a display according to a fifth embodiment of the present invention; and

FIG. 38 is a fragmentary cross-sectional view of a display according to a sixth embodiment of the present invention.

### DESCRIPTION OF THE PREFERRED EMBODIMENTS

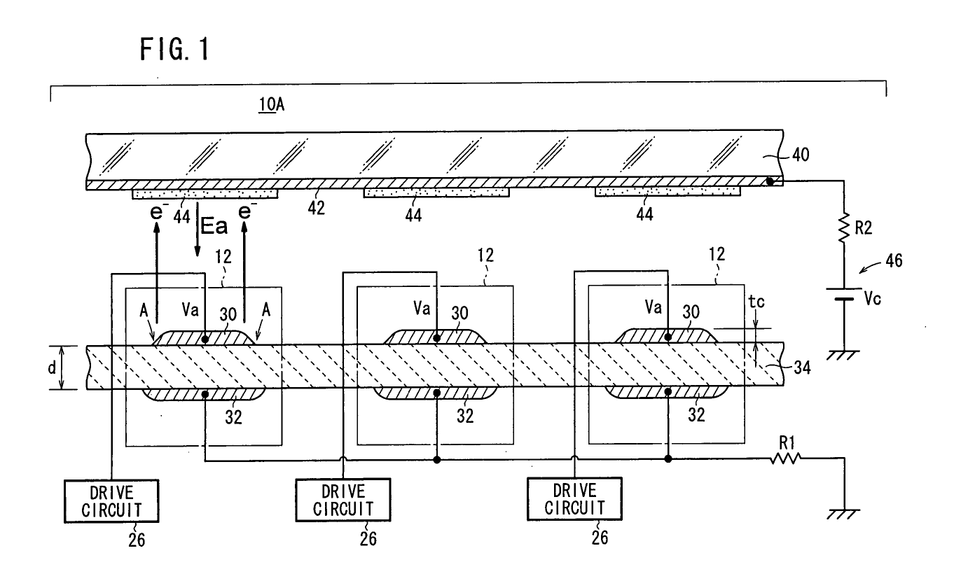

Displays, and methods for driving the same, according to embodiments of the present invention will be described below with reference to FIGS. 1 through 38.

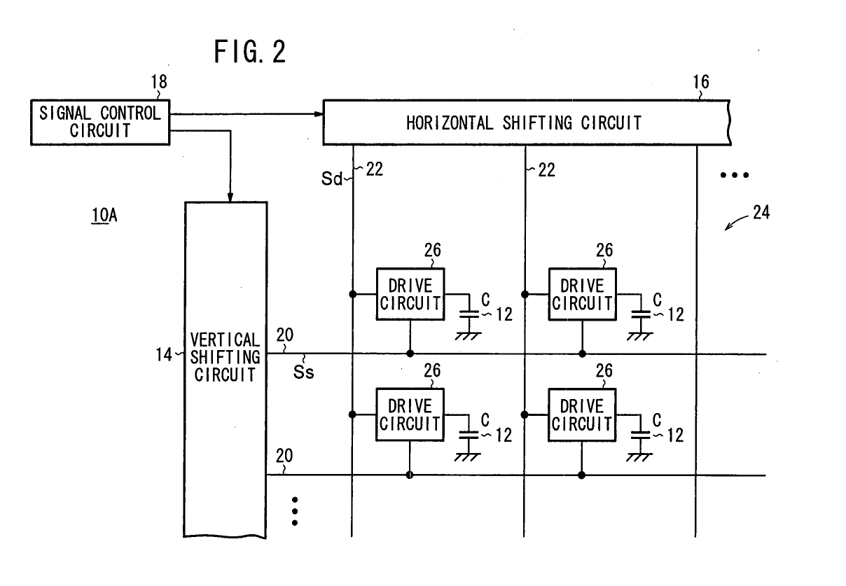

As shown in FIG. 1A, a display 10A according to a first embodiment of the present invention has an array of electron emitters 12 associated with respective pixels. As shown in FIG. 2, the display 10A also has as many row select lines 20 as the number of rows of pixels (electron emitters 12), and as many signal lines 22 as the number of columns of pixels. The display 10A further includes a vertical shifting circuit 14 for supplying selection signals Ss selectively to the select lines 20 for successively selecting rows of electron emitters 12, and a horizontal shifting circuit 16 for outputting parallel pixel signals Sd to the signal lines 22 to supply the pixel signals Sd to the electron emitters 12 of the row (selected row) which has been selected by the vertical shifting circuit 14. The display 10A also includes a signal control circuit 18, for controlling the vertical shifting circuit 14 and the horizontal shifting circuit 16 based on a video signal Sv and a synchronizing signal Sc which are input thereto, and a drive section 24.

The drive section 24 has a plurality of drive circuits 26 arrayed in association with the pixels (electron emitters 12). As shown in FIG. 1, each of the drive circuits 26 applies a drive voltage Va between a first electrode (cathode electrode) 30 and a second electrode (anode electrode) 32 of the corresponding electron emitter 12 to drive the electron emitter 12. Details of the drive circuits 26 will be described later.

As shown in FIG. 1, each of the electron emitters 12 has a plate-like emitter 34, the cathode electrode 30 disposed on a face side of the emitter 34, and the anode electrode 32 disposed on a reverse side of the emitter 34. Since the electron emitter 12 is of a structure in which the emitter 34 is sandwiched between the cathode electrode 30 and the anode electrode 32, it provides a capacitive load. Therefore, the electron emitter 12 may be regarded as a capacitor C (see FIG. 2).

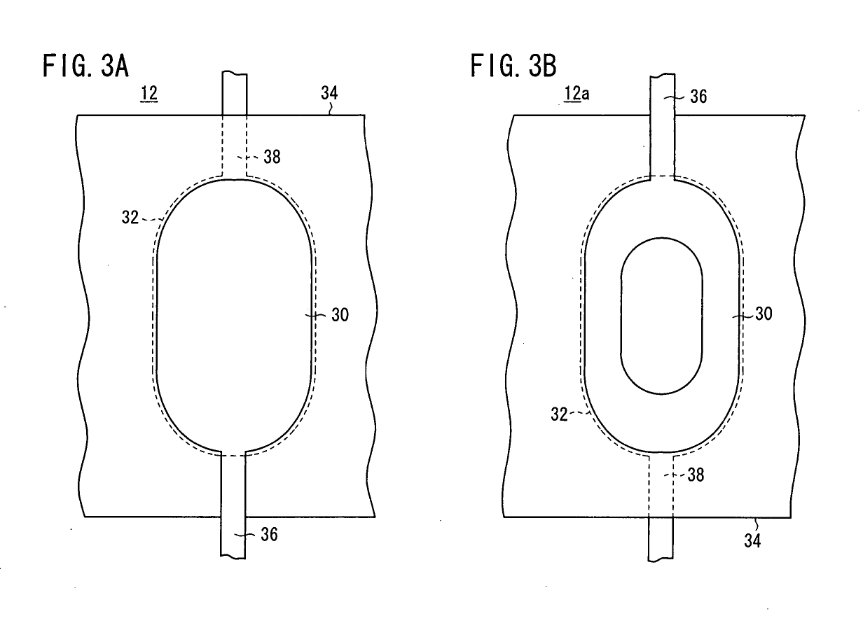

The drive voltage Va from the drive circuit 26 is applied between the cathode electrode 30 and the anode electrode 32. In FIG. 1, the anode electrode 32 is connected to GND (ground) through a resistor R1, and hence is kept at a zero potential. However, the anode electrode 32 may be held at a potential other than zero. As shown in FIGS. 3A and 3B, for example, the drive voltage Va is applied between the cathode electrode 30 and the anode electrode 32 through a lead electrode 36 connected to the cathode electrode 30 and a lead electrode 38 connected to the anode electrode 32.

As shown in FIG. 1, if the electron emitters 12 are used as light-emitting elements or display pixels, then a transparent panel 40 of glass or acrylic resin is placed over the cathode electrodes 30, and a collector electrode 42 comprising a transparent electrode, for example, is mounted on the reverse side of the transparent panel 40, i.e., on the surface of the transparent panel 40 facing the cathode electrodes 30. The collector electrode 42 is coated with phosphors 44. A bias power supply 46, providing a bias voltage Vc, is connected to the collector electrode 42 through a resistor R2.

The electron emitters 12 are placed in a vacuum. As shown in FIG. 1, electric field concentration points A are present in each of the electron emitters 12. Each of the electric field concentration points A may be defined as a point including a triple point, where the cathode electrode 30, the emitter 34, and the vacuum coexist.

The vacuum level in the atmosphere should preferably be in a range from 10² to 10⁻⁶ Pa, and more preferably in a range from 10⁻³ to 10⁻⁵ Pa.

The reason for the above ranges is that, in a lower vacuum, first, many gas molecules will be present within the space and a plasma can easily be generated. By contrast, if an overly intensive plasma were generated, many positive ions would impinge upon the cathode electrode 30 and damage the same, and secondly, emitted electrons would tend to impinge upon gas molecules prior to arrival at the collector electrode 42, failing to sufficiently excite the phosphor 44 with sufficiently accelerated electrons under the collector voltage Vc.

In a higher vacuum, although electrons are liable to be emitted from an electric field concentration point A, the structural body supports and vacuum seals would have to be large in size, hindering efforts to keep the electron emitter small in size.

The emitter 34 is made of a dielectric material. The dielectric material preferably is a dielectric material having a relatively large dielectric constant, e.g., a dielectric constant of 1000 or larger. Dielectric materials of such a nature may be ceramics including barium titanate, lead zirconate, lead magnesium niobate, lead nickel niobate, lead zinc niobate, lead manganese niobate, lead magnesium tantalate, lead nickel tantalate, lead antimony tinate, lead titanate, lead magnesium tungstenate, lead cobalt niobate, etc., or a combination of any of these materials, or a material which chiefly contains 50 weight % or more of any of these materials, or ceramics to which there is added an oxide such as lanthanum, calcium, strontium, molybdenum, tungsten, barium, niobium, zinc, nickel, manganese, or the like, or a combination of these materials, or any of other compounds.

For example, a two-component material nPMN-mPT (n, m represent molar ratios) of lead magnesium niobate (PMN) and lead titanate (PT) has its Curie point lowered for a larger specific dielectric constant at room temperature if the molar ratio of PMN is increased.

Particularly, a dielectric material where n=0.85−1.0 and m=1.0−n is preferable because its specific dielectric constant is 3000 or larger. For example, a dielectric material where n=0.91 and m=0.09 has a specific dielectric constant of 15000 at room temperature, and a dielectric material where n=0.95 and m=0.05 has a specific dielectric constant of 20000 at room temperature.

For increasing the specific dielectric constant of a three-component dielectric material consisting of lead magnesium niobate (PMN), lead titanate (PT) and lead zirconate (PZ), it is preferable to achieve a composition close to a morphotropic phase boundary (MPB) between a tetragonal system and a quasi-cubic system, or a tetragonal system and a rhombohedral system, as well as to increase the molar ratio of PMN. For example, a dielectric material where PMN:PT:PZ=0.375:0.375:0.25 has a specific dielectric constant of 5500, and a dielectric material where PMN:PT:PZ=0.5:0.375:0.125 has a specific dielectric constant of 4500, which is particularly preferable. Furthermore, it is preferable to increase the dielectric constant by introducing a metal such as platinum into the dielectric materials within a range to keep them insulative. For example, a dielectric material may be mixed with 20 weight % of platinum.

The emitter 34 may be in the form of a piezoelectric/electrostrictive layer or an anti-ferrodielectric layer. If the emitter 34 comprises a piezoelectric/electrostrictive layer, then it may be made of ceramics such as lead zirconate, lead magnesium niobate, lead nickel niobate, lead zinc niobate, lead manganese niobate, lead magnesium tantalate, lead nickel tantalate, lead antimony tinate, lead titanate, barium titanate, lead magnesium tungstenate, lead cobalt niobate, or the like, or a combination of any of these materials.

The emitter 34 may be made of primary components including 50 wt % or more of any of the above compounds. Of the above ceramics, ceramics including lead zirconate are most frequently used as constituents of the piezoelectric/electrostrictive layer for the emitter 34.

If the piezoelectric/electrostrictive layer is made of ceramics, then lanthanum, calcium, strontium, molybdenum, tungsten, barium, niobium, zinc, nickel, manganese, or the like, or a combination of these materials or any of other compounds, may be added to the ceramics.

For example, the piezoelectric/electrostrictive layer should preferably be made of ceramics including as primary components thereof lead magnesium niobate, lead zirconate, and lead titanate, and also including lanthanum and strontium.

The piezoelectric/electrostrictive layer may be dense or porous. If the piezoelectric/electrostrictive layer is porous, then it should preferably have a porosity of 40% or less.

If the emitter 34 is in the form of an anti-ferrodielectric layer, then the anti-ferrodielectric layer may be made of lead zirconate as a primary component, lead zirconate and lead tin as primary components, lead zirconate with lanthanum oxide added thereto, or lead zirconate and lead tin as components with lead zirconate and lead niobate added thereto.

The anti-ferrodielectric layer may be porous. If the anti-ferrodielectric layer is porous, then it should preferably have a porosity of 30% or less.

If the emitter 34 is made of strontium tantalate bismuthate, then its polarization inversion fatigue is small. Materials whose polarization inversion fatigue is small are laminar ferrodielectric compounds expressed by the general formula (BiO₂)²⁺(Aₘ₋₁BₘO₃ₘ₊₁)²⁻. Ions of the metal A are Ca²⁺, Sr²⁺, Ba²⁺, Pb²⁺, Bi³⁺, La³⁺, etc., and ions of the metal B are Ti⁴⁺, Ta⁵⁺, Nb⁵⁺, etc.

The baking temperature can be lowered by adding glass, such as lead borosilicate glass or the like, or other compounds having a low melting point (e.g., bismuth oxide or the like), to the piezoelectric/electrostrictive/anti-ferrodielectric ceramics.

If the emitter 34 is made of a non-lead-based material, then a material having a high melting point or a high evaporation temperature may be used, so as to be less liable to damage by impingement of electrons or ions.

The degree of thickness d (see FIG. 1) of the emitter 34 between the cathode electrode 30 and the anode electrode 32 will be described below. If the voltage between the cathode electrode 30 and the anode electrode 32, i.e., the voltage that appears between the cathode electrode 30 and the anode electrode 32 when the drive voltage Va output from the drive circuit 26 is applied between the cathode electrode 30 and the anode electrode 32, is represented by Vak, then it is preferable to establish the thickness d such that a polarization inversion or polarization change occurs with an electric field E expressed by E=Vak/d. That is, as the thickness d becomes smaller, the polarization reversal or polarization change can occur at a lower voltage, enabling the electron emitter 12 to emit electrons when driven by a lower voltage, e.g., less than 100 V.

The cathode electrode 30 should preferably be made of a conductor having a small sputtering yield and a high evaporation temperature in vacuum. For example, materials having a sputtering yield of 2.0 or less at 600 V in Ar⁺ and an evaporation pressure of 1.3×10⁻³ Pa at a temperature of 1800 K or higher are preferable. Such materials include platinum, molybdenum, tungsten, etc. The cathode electrode 30 may be made of a conductor, which is resistant to high-temperature oxidizing atmospheres, e.g., a metal, an alloy, a mixture of insulative ceramics and a metal, or a mixture of insulative ceramics and an alloy. Preferably, the cathode electrode 30 should be composed primarily of a precious metal having a high melting point, e.g., platinum, iridium, palladium, rhodium, molybdenum, or the like, or an alloy of silver and palladium, silver and platinum, platinum and palladium, or the like, or a cermet of platinum and ceramics. Further, the cathode electrode 30 should preferably be made of platinum only or a material chiefly composed of a platinum-base alloy. The electrodes should preferably be made of carbon or a graphite-base material, e.g., diamond thin film, diamond-like carbon, or carbon nanotubes. Ceramics to be added to the electrode material should preferably have a proportion ranging from 5 to 30% by volume.

Furthermore, the cathode electrode 30 should preferably be made of an organic metal paste, which can produce a thin film after being baked. For example, a platinum resinate paste or the like should preferably be used. An oxide electrode for suppressing polarization inversion fatigue, which is made of ruthenium oxide, iridium oxide, strontium ruthenate, La₁₋ₓSrₓCoO₃ (e.g., x=0.3 or 0.5), La₁₋ₓCaₓMnO₃, La₁₋ₓCaₓMn_{1-y}Co_{y}O₃ (e.g., x=0.2, y=0.05), or a mixture of any one of these compounds, and a platinum resinate paste, for example, is preferable.

The cathode electrode 30 may be made of any of the above materials by any of various thick-film forming processes, including screen printing, spray coating, coating, dipping, electrophoresis, etc., or any of various thin-film forming processes, including sputtering, ion beam processing, vacuum evaporation, ion plating, chemical vapor deposition (CVD), plating, etc. Preferably, the cathode electrode 30 is made by any of the above thick-film forming processes.

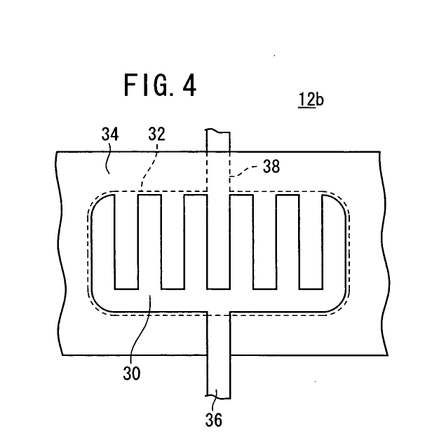

The shape in plan of the cathode electrode 30 may be an elliptical shape as shown in FIG. 3A, or a ring shape as shown in FIG. 3B. Alternatively, the shape in plan of the cathode electrode 30 may be a comb-toothed shape, in the case of an electron emitter 12b according to a second modification, as shown in FIG. 4.

The ring-shaped or comb-toothed cathode electrode 30 is effective to increase the number of triple points, between the cathode electrode 30, the emitter 34, and the vacuum, as electric field concentration points A for increased electron emission efficiency.

The cathode electrode 30 should preferably have a thickness tc (see FIG. 1) of 20 μm or less, and preferably of 5 μm or less. Therefore, the thickness tc of the cathode electrode 30 may be 100 nm or less. If the thickness tc of the cathode electrode 30 is extremely small (10 nm or less), then electrons are emitted from the interface between the cathode electrode 30 and the emitter 34, for further increased electron emission efficiency.

The anode electrode 32 is made of the same material and is produced according to the same process as the cathode electrode 30. Preferably, the anode electrode 32 is made according to one of the above thick-film forming processes. The anode electrode 32 should preferably have a thickness of 20 μm or less, and preferably of 5 μm or less.

Each time the emitter 34, the cathode electrode 30, or the anode electrode 32 is formed, the assembly is heated (sintered) into an integral structure. Depending on how the cathode electrode 30 and the anode electrode 32 are formed, however, the heating (sintering) process for producing an integral structure may not be required.

The sintering process for integrally combining the emitter 34, the cathode electrode 30, and the anode electrode 32 may be carried out at a temperature ranging from 500 to 1400° C., preferably from 1000 to 1400° C. For heating the emitter 34, which is in the form of a film, the emitter 34 should preferably be sintered together with its evaporation source in a controlled atmosphere, so that the composition of the emitter 34 will not become unstable at high temperatures.

The emitter 34 may be covered with a suitable member and then sintered, such that the surface of the emitter 34 will not be exposed directly to the sintering atmosphere.

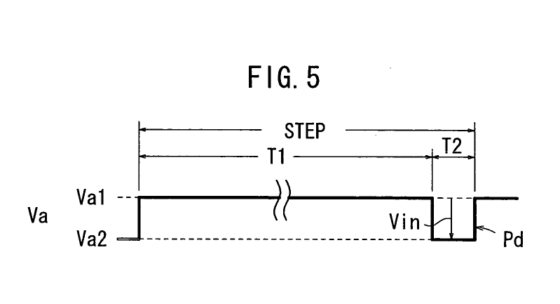

The principles of electron emission of the electron emitter 12 will be described below with reference to FIGS. 1 and 5 through 10B. First, as shown in FIG. 5, a drive voltage Va output from the drive circuit 26 has repeated steps, each including a period T1 in which a first voltage Va1 that causes the potential of the cathode electrode 30 to be higher than the potential of the anode electrode 32 is output, and a period T2 in which a second voltage Va2 that causes the potential of the cathode electrode 30 to be lower than the potential of the anode electrode 32 is output. The voltage Va2, which is output during the period T2, is referred to as a drive pulse Pd.

The drive pulse Pd has an amplitude Vin produced by subtracting the voltage Va2 from the voltage Va1 (Vin=Va1−Va2). Depending on the amplitude level, electrons may or may not be emitted from the electron emitter 12.

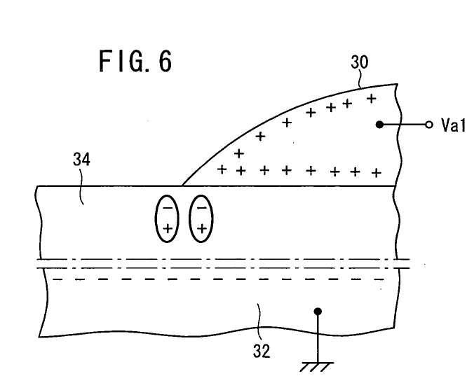

As shown in FIG. 6, during the period T1 the voltage Va1 is applied between the cathode electrode 30 and the anode electrode 32 to polarize the emitter 34. As shown in FIG. 5, the voltage Va1 may be a DC voltage comprising a single voltage pulse or a succession of voltage pulses. The period T1 is preferably longer than the period T2 for providing sufficient polarization. For example, the period T1 is preferably 100 microseconds or longer, so that the absolute value of the polarizing voltage Va1 is set to be smaller than the absolute value of the voltage Va2, thereby reducing power consumption at the time the voltage Va1 is applied and preventing damage to the cathode electrode 30.

The voltages Va1, Va2 are of levels sufficient to reliably polarize the emitter 34 into positive and negative poles. For example, if the dielectric material of the emitter 34 has a coercive voltage, then the absolute values of voltages Va1, Va2 should preferably be equal to or higher than the coercive voltage.

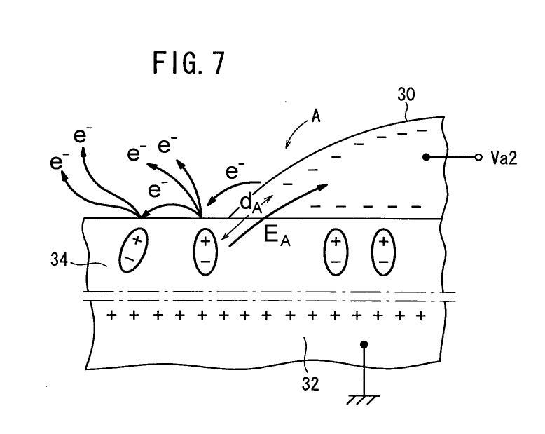

When the drive pulse Pd having a predetermined amplitude level is applied between the cathode electrode 30 and the anode electrode 32, the polarization is inverted or changed in at least a portion of the emitter 34, as shown in FIG. 7. The portion of the emitter 34 where the polarization is inverted or changed includes a portion directly below the cathode electrode 30 and a portion whose surface is exposed in the vicinity of the cathode electrode 30, because the polarization seeps into the portion of the emitter 34 whose surface is exposed in the vicinity of the cathode electrode 30. When the polarization is inverted or changed, a local electric field concentration occurs at the cathode electrode 30 and the positive poles of dipole moments near the cathode electrode 30, drawing primary electrons from the cathode electrode 30. The primary electrons from the cathode electrode 30 impinge upon the emitter 34, causing the emitter 34 to emit secondary electrons.

If the electron emitter 12 has a triple point A formed by cathode electrode 30, the emitter 34, and the vacuum, in the present embodiment, primary electrons are drawn from the portion of the cathode electrode 30 near the triple point A, and the primary electrons drawn from the triple point A impinge upon the emitter 34, which emits secondary electrons. If the thickness of the cathode electrode 30 is very small (up to 10 nm), then electrons are emitted from the interface between the cathode electrode 30 and the emitter 34.

Operation of the electron emitter 12 at a time when the drive pulse Pd having a predetermined amplitude level is applied will be described in greater detail below.

When a drive pulse Pd having a predetermined amplitude level is applied between the cathode electrode 30 and the anode electrode 32, secondary electrons are emitted from the emitter 34, as described above. That is, dipole moments that are charged in the emitter 34 in the vicinity of the cathode electrode 30 have positive poles serving as a local anode, drawing electrons from the cathode electrode 30. Some of the drawn electrons are attracted to the collector electrode 42 (see FIG. 1) and excite the phosphor 44, which emits fluorescent light. Some of the drawn electrons impinge upon the emitter 34, which emit secondary electrons that are attracted to the collector electrode 42 and also excite the phosphor 44.

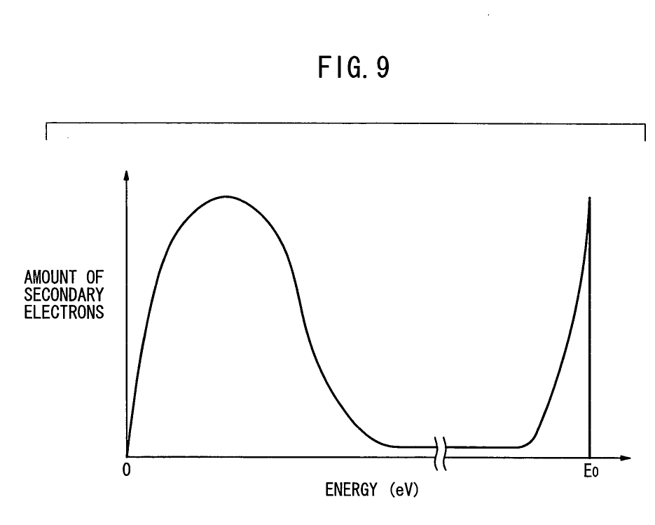

A distribution of the emitted secondary electrons will be described below with reference to FIG. 9. As shown in FIG. 9, most of the secondary electrons have an energy level that is nearly zero. When the secondary electrons are emitted from the surface of the emitter 34 in a vacuum, they move according to a surrounding electric field distribution. Specifically, the secondary electrons are accelerated from an initial velocity of almost 0 (m/sec) according to the surrounding electric field distribution. Therefore, as shown in FIG. 1, if an electric field Ea occurs between the emitter 34 and the collector electrode 42, then the secondary electrons have a trajectory determined along the electric field Ea. That is, an electron source which improves the straightness of emitted electrons is realized. The secondary electrons with the low initial velocity are electrons in a solid state, which gain energy by coulomb-attracted impingement of primary electrons, and are expelled out of the emitter 34.

As can be seen from FIG. 9, secondary electrons are emitted having an energy level corresponding to the energy E₀ of primary electrons. The secondary electrons (reflected electrons) are produced by primary electrons emitted from the cathode electrode 30 and scattered in the vicinity of the surface of the emitter 34. The secondary electrons referred to in the present specification are defined as including such reflected electrons as well as Auger electrons.

If the thickness of the cathode electrode 30 is very small (up to 10 nm), then primary electrons emitted from the cathode electrode 30 are reflected at the interface between the cathode electrode 30 and the emitter 34 and directed toward the collector electrode 42.

As shown in FIG. 7, the intensity E_{A} of the electric field at the electric field concentration point A is expressed by E_{A}=V(1a, 1k)/d_{A}, where V(1a, 1k) represents the potential difference between a local anode and a local cathode, and d_{A} represents the distance between a local anode and a local cathode. Since the distance d_{A} between a local anode and a local cathode is very small, the intensity E_{A} of the electric field required to emit electrons can easily be achieved. In FIG. 7, an increase in the intensity E_{A} of the electric field is indicated by the solid-line arrow. This leads to a reduction in a voltage Vak.

As the emission of electrons from the cathode electrode 30 progresses, atoms from the emitter 34, which are evaporated and floating due to Joule heat, are ionized into positive ions and electrons by the emitted electrons, wherein the electrons produced by ionization ionize atoms of the emitter 34. Therefore, the number of electrons is exponentially increased. When such a process goes on, electrons and positive ions are present in a neutral fashion, developing a local plasma. Secondary electrons are also considered as promoting ionization. Positive ions produced by ionization could impinge upon the cathode electrode 30, thus damaging the cathode electrode 30.

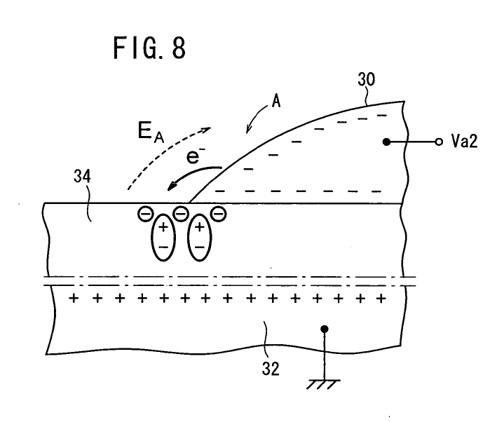

As shown in FIG. 8, electrons drawn from the cathode electrode 30 are attracted to positive poles of dipole moments of the emitter 34, which produce a local anode, negatively charging the surface of the emitter 34 in the vicinity of the cathode electrode 30. As a result, the factor that accelerates the electrons (local potential difference) is lessened, no potential is present for the emission of secondary electrons, and the surface of the emitter 34 becomes further negatively charged.

Therefore, the positive polarity of the local anode produced by the dipole moments is reduced, and the intensity E_{A} of the electric field between a local anode and a local cathode is reduced, stopping the emission of electrons. In FIG. 8, a reduction in the intensity E_{A} of the electric field is indicated by the broken-line arrow.

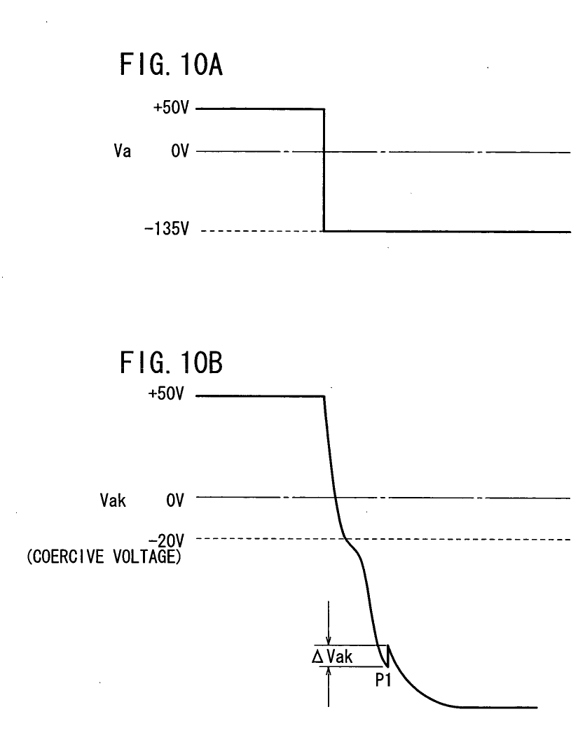

Specifically, as shown in FIG. 10A, when the drive voltage Va is applied between the cathode electrode 30 and the anode electrode 32, such that the voltage Va1 is +50 V and the voltage Va2 is −135 V, for example, a voltage change ΔVak, which occurs between the cathode electrode 30 and the anode electrode 32 at a peak time point P1 when electrons are emitted, falls within, i.e., does not exceed, 20 V (shown as about 10 V in FIG. 10B), and hence the voltage Va is substantially free of changes. Therefore, almost no positive ions are produced, and the cathode electrode 30 is prevented from being damaged by positive ions, resulting in a longer service life of the electron emitter 12.

The dielectric breakdown voltage of the emitter 34 should preferably be at least 10 kV/mm. In the present embodiment, if the thickness d of the emitter 34 is 20 μm, for example, the emitter 34 will not suffer dielectric breakdown, even when a drive voltage of −135 V is applied between the cathode electrode 30 and the anode electrode 32.

When electrons emitted from the emitter 34 impinge again upon the emitter 34, or when atoms are ionized in the vicinity of the surface of the emitter 34, the emitter 34 could possibly become damaged, inducing crystal defects and resulting in a fragile structure.

The emitter 34 should preferably be made of a dielectric material having a high evaporation temperature in vacuum, e.g., BaTiO₃ containing no Pb or the like. Atoms of the emitter 34 formed in this manner are less likely to evaporate due to Joule heat, and are prevented from becoming ionized by electrons. This approach is effective in protecting the surface of the emitter 34.

The pattern shape and potential of the collector electrode 42 may appropriately be changed, and control electrodes or the like may be disposed between the emitter 34 and the collector electrode 42, to establish a desired electric field distribution between the emitter 34 and the collector electrode 42, thereby controlling the trajectory of emitted secondary electrons, while converging, enlarging, and modifying the electron beam diameter with ease.

The realization of an electron source which improves the straightness of emitted electrons, and the ease with which the trajectory of emitted secondary electrons can be controlled, are advantageous for reducing the pitch of pixels of a display, when such pixels are provided by electron emitters 12.

Since the electron emitters 12 output secondary electrons emitted from the emitter 34, the service life and reliability of electron emission can be increased. The electron emitters 12 can thus be used in various applications and should find widespread usage.

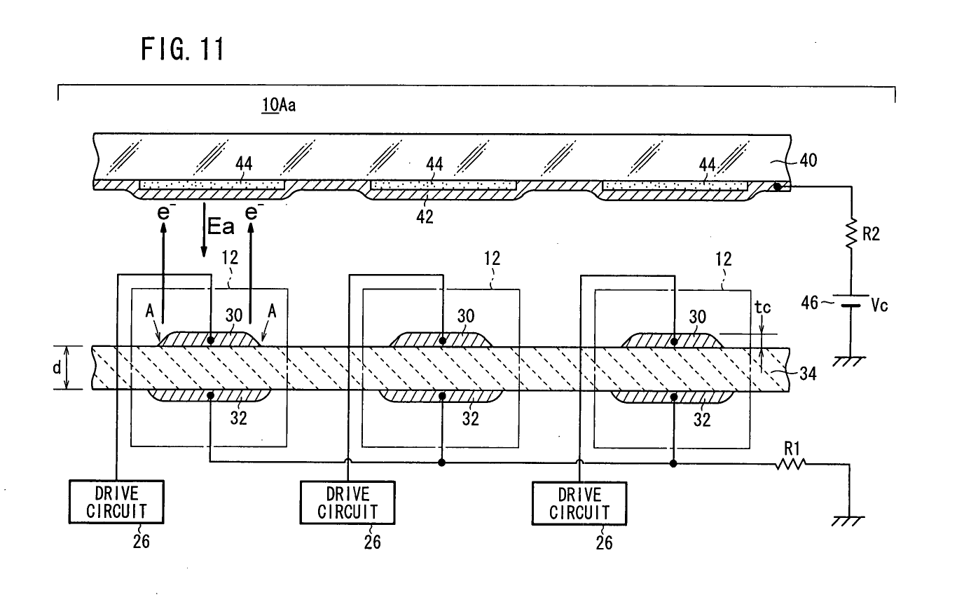

In the above embodiment, the collector electrode 42 is disposed on a reverse side of the transparent panel 40, and phosphors 44 are disposed on the surface of the collector electrode 42 that faces the cathode electrode 30. In a display 10Aa according to a first modification, shown in FIG. 11, the phosphors 44 are disposed on the reverse side of the transparent panel 40, and the collector electrode 42 is disposed in covering relation to the phosphors 44.

The first modification is for use in a CRT or the like, where the collector electrode 42 functions as a metal backing. Secondary electrons emitted from the emitter 34 pass through the collector electrode 42 into the phosphors 44, thereby exciting the phosphors 44. Therefore, the collector electrode 42 is of a thickness that allows electrons to pass therethrough, preferably 100 nm or less thick. However, if the kinetic energy of the secondary electrons is made larger, the thickness of the collector electrode 42 may be increased.

This arrangement offers the following advantages:

(1) If the phosphor 44 is not electrically conductive, then the phosphor 44 is prevented from becoming charged (negatively), and an electric field for accelerating electrons can be maintained.

(2) The collector electrode 42 reflects light emitted from the phosphor 44, and discharges the light emitted from the phosphor 44 efficiently toward the transparent panel 40 (light emission surface).

(3) Secondary electrons are prevented from impinging excessively upon the phosphor 44, thus preventing the phosphor 44 from becoming deteriorated or producing unwanted gases.

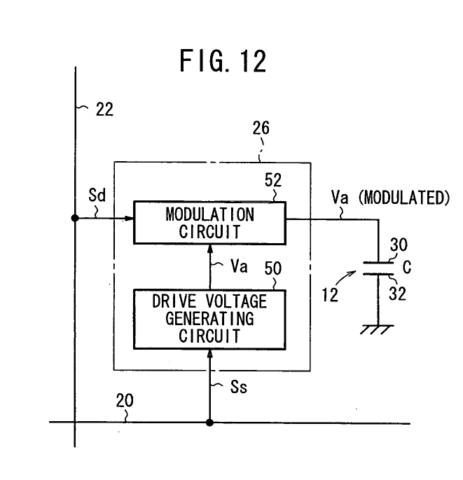

As shown in FIG. 12, each of the drive circuits 26 has a drive voltage generating circuit 50 and a modulation circuit 52.

The drive voltage generating circuit 50 generates a drive signal Va, to be applied between the cathode electrode 30 and the anode electrode 32 of a corresponding electron emitter 12, based on an instruction signal (selection signal Ss) from the corresponding selection line 20.

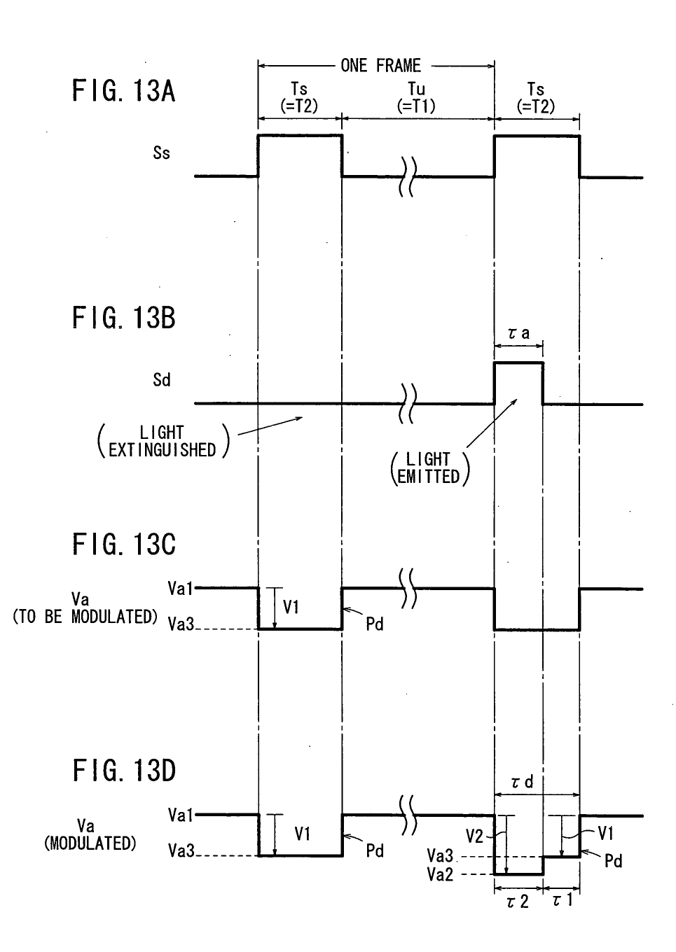

As shown in FIG. 13A, if a period in which an instruction is provided to select one row is a selection period Ts (which is the same as the period T2 described above), if a period from the start of the selection instruction to the start of a next selection instruction is referred to as one frame (about 16.7 msec), and a period in one frame other than the selection period is referred to as a non-selection period Tu (which is the same as the period T1), then the selection signal Ss has a voltage waveform comprising a positive pulse output in the selection period Ts and a reference level (e.g., 0 V) in the non-selection period Tu. If the number of rows of the display 10A is 64, then the selection period Ts for selecting one row is 260 μsec.

The drive voltage Va generated by the drive voltage generating circuit 50 has a waveform (see FIG. 13C) comprising a drive pulse Pd in timed relation to a selection instruction from the selection line 20.

Based on a pixel signal Sd from the corresponding signal line 22, the modulating circuit 52 modulates the amplitude of the drive pulse Pd stepwise to control the luminance gradation of the corresponding pixel. If the pixel signal Sd is a signal for extinguishing light, then, as shown in the lefthand half of FIG. 13B, the signal Sd has a waveform maintained at the reference level (e.g., 0 V). If the pixel signal Sd is a signal for emitting light, then, as shown in a latter half of FIG. 13B, the signal Sd has a waveform comprising a positive pulse whose pulse duration Ta represents a display gradation.

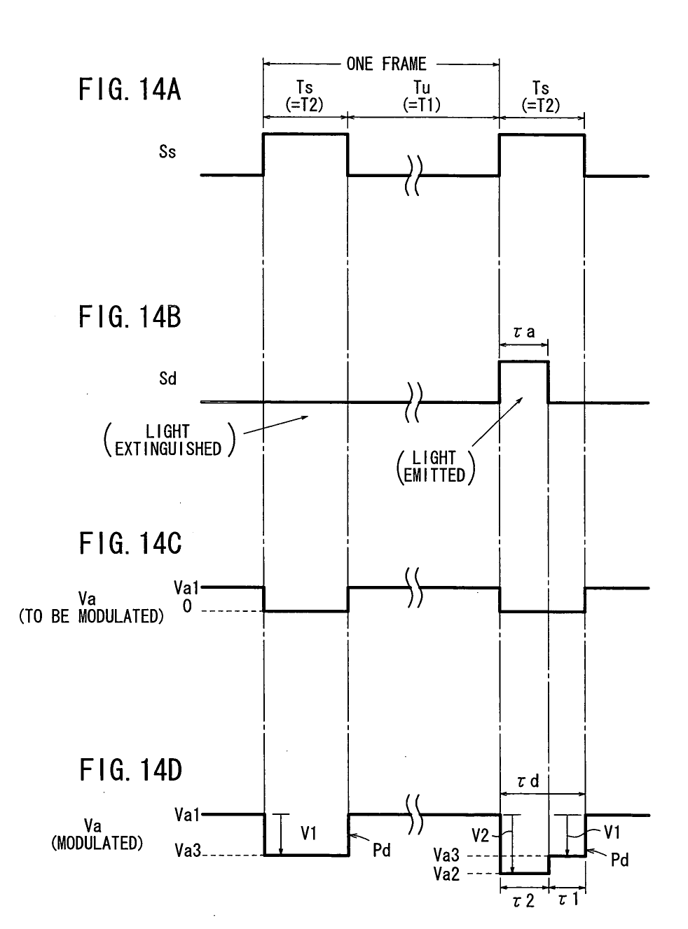

Two modulating processes for the drive circuit 26 will be described below with reference to FIGS. 13A through 14D.

Initially, the first modulating process will be described below. As shown in FIG. 13C, a drive voltage Va (before being modulated) generated by the drive voltage generating circuit 50 has a voltage waveform including a drive pulse Pd, which has a first amplitude V1 (voltage Va3) that is not sufficient enough to emit electrons from the electron emitter 12, in timed relation to a selection instruction from the selection line 20.

If the pixel signal Sd is a signal for extinguishing light, then, as shown in a lefthand half of FIG. 13D, the modulation circuit 52 keeps the amplitude of the drive pulse Pd at the first amplitude V1. If the pixel signal Sd is a signal for emitting light, then, as shown in a latter half of FIG. 13D, the modulation circuit 52 sets the amplitude of the drive pulse Pd to a second amplitude V2 (voltage Va2) that is sufficient to emit electrons from the electron emitter 12, and further modulates the pulse duration τ2 of the second amplitude V2 based on a gradation component (pulse duration Ta shown in FIG. 13B) which is contained in the pixel signal Sd.

Specifically, the drive circuit 26 modulates the pulse duration τ2 to satisfy the following relationship:
τd=τ1+τ2
|V2|>|V1|
τ2∝τa
where τd represents the pulse duration of the drive pulse Pd, V1 the first amplitude of the drive pulse Pd, V2 the second amplitude of the drive pulse Pd, τ1 the pulse duration of the first amplitude, τ2 the pulse duration of the second amplitude, and τa the pulse duration at the time the pixel signal Sd is a signal for emitting light.

Since the pulse duration τd of the drive pulse Pd is 260 μsec, the pulse duration τ2 of second amplitude can be increased to a maximum of 260 μsec. Therefore, it is possible to express 256 gradations, for example.

The second modulating process will be described below with reference to FIGS. 14A through 14D. A drive voltage Va generated by the drive voltage generating circuit 50 has a voltage waveform including a drive pulse Pd, which has an amplitude (including a reference level 0) that is not sufficient enough to emit electrons from the electron emitter 12, in timed relation to a selection instruction from the selection line 20.

If the pixel signal Sd is a signal for extinguishing light, then, as shown in a lefthand half of FIG. 14D, the modulation circuit 52 modulates the amplitude of the drive pulse Pd at a first amplitude V1 insufficient to emit electrons from the electron emitter 12. If the pixel signal Sd is a signal for emitting light, then, as shown in a latter half of FIG. 14D, the modulation circuit 52 sets the amplitude of the drive pulse Pd to a second amplitude V2 that is sufficient to emit electrons from the electron emitter 12, and further modulates the pulse duration τ2 of the second amplitude V2 based on a gradation component (pulse duration τa) which is contained in the pixel signal Sd.

Reasons for employing the above modulating processes will be described below. Other than the modulating processes according to the present embodiment, processes for controlling gradation of a pixel include a process for controlling the collector voltage Vc, a process for controlling the voltage Va2 of the drive voltage Va, and a process for controlling the voltage Va1 of the drive voltage Va.

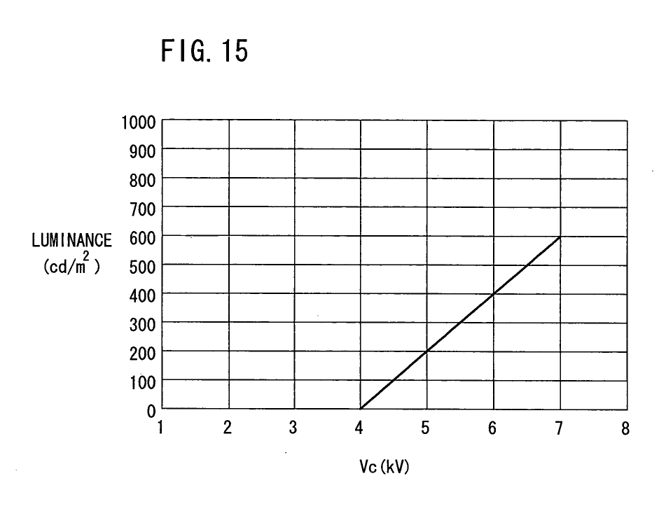

The process for controlling the collector voltage Vc is based on the fact that the collector voltage Vc and luminance are linearly related to each other as shown in FIG. 15. For example, if the voltage Va2 of the drive voltage Va is −135 V, then the collector voltage Vc is varied from 4 kV to 7 kV to change the luminance from 0 to 600 (cd/m²). This process, however, is not practical, since it requires high voltages to be controlled.

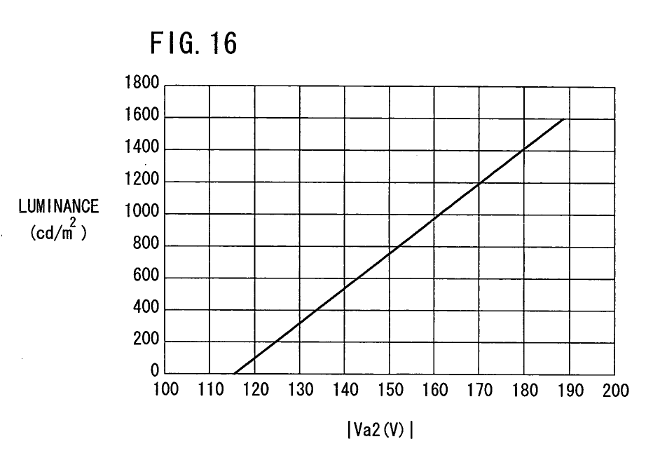

The process for controlling the voltage Va2 of the drive voltage Va is based on the fact that the voltage Va2 and luminance are linearly related to each other as shown in FIG. 16. For example, the voltage Va2 is varied from about 118 V to 188 V to change the luminance from 0 to 1600 (cd/m²). This process, however, is not practical in terms of cost, since it requires analog voltage control over the voltage Va2, and hence needs an expensive IC such as an operational amplifier or the like.

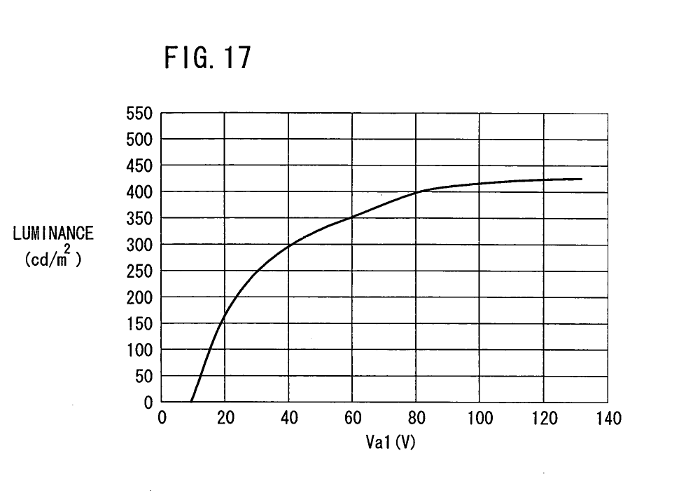

The process for controlling the voltage Va1 of the drive voltage Va is based on the fact that the voltage Va1 and luminance are nonlinearly related to each other as shown in FIG. 17. Therefore, it is difficult to control the voltage Va1, and circuit refinements are needed, since analog voltage control over the voltage Va1 is necessary.

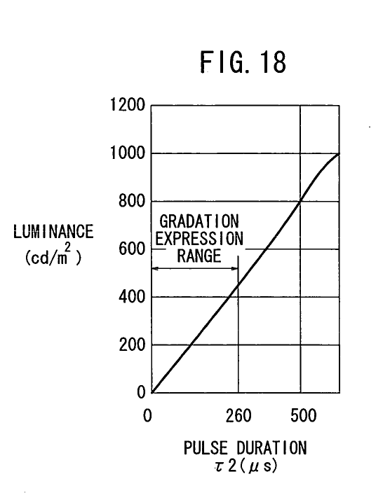

The modulating processes according to the present embodiment are based on the fact that the pulse duration τ2 of the second amplitude V2 and luminance are linearly related to each other as shown in FIG. 18. For example, the pulse duration τ2 is varied from 0 μsec to about 600 μsec to change the luminance from 0 to about 1020 (cd/m²). Since the pulse duration τ2 of the second amplitude V2 may be controlled, highly fine gradation representations can be achieved using an inexpensive digital control process. According to the present embodiment, because the pulse duration τ2 is modulated from 0 μsec to 260 μsec, the luminance can be changed from 0 to about 400 (cd/m²).

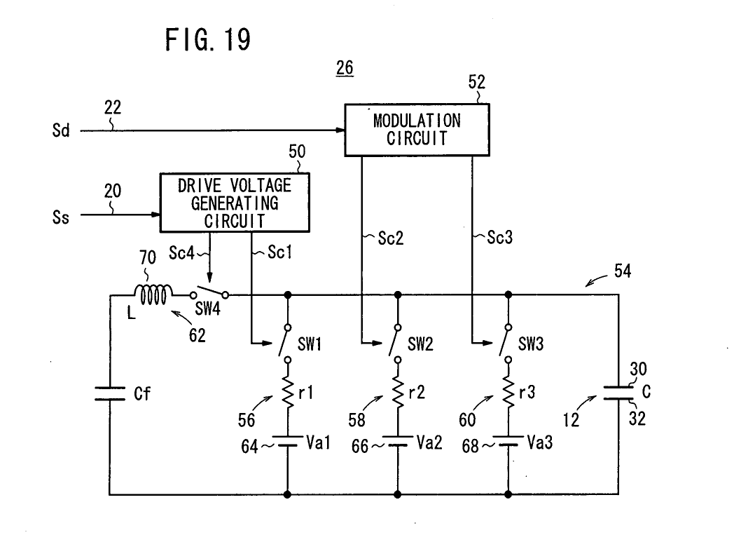

A drive circuit 26 according to a preferred embodiment of the present invention will be described below with reference to FIGS. 19 through 24C. As shown in FIG. 19, the drive circuit 26 according to the present embodiment comprises a drive voltage generating circuit 50 and a modulation circuit 52, as described above, together with an electric power retrieval circuit 54.

A conceptual arrangement of the electric power retrieval circuit 54 will be described below. A buffer capacitor Cf and three series-connected circuits (first through third series-connected circuits 56, 58, 60) are connected in parallel to each other between both electrodes (cathode electrode 30 and anode electrode 32) of a capacitor C serving as the electron emitter 12. A fourth series-connected circuit 62 is also connected between the capacitor C and the buffer capacitor Cf.

In the embodiment shown in FIG. 19, one buffer capacitor Cf is connected to one capacitor C. However, one buffer capacitor Cf may be connected to a plurality of capacitors C serving as the display 10A, and hence the number of buffer capacitors Cf is arbitrary.

The first series-connected circuit 56 comprises a first switching circuit SW1, a current-suppressing first resistor r1, and a positive power supply 64 (voltage Va1), which are connected in series. The second series-connected circuit 58 comprises a second switching circuit SW2, a current-suppressing second resistor r2, and a negative power supply 66 (voltage Va2), which are connected in series.

The third series-connected circuit 60 comprises a third switching circuit SW3, a current-suppressing third resistor r3, and a negative power supply 68 (voltage Va3), which are connected in series. The fourth series-connected circuit 62 comprises a fourth switching circuit SW4 and an inductor 70 (inductance L), which are connected in series.

The drive voltage generating circuit 50 generates and outputs control signals Sc1, Sc4 for controlling the first switching circuit SW1 and the fourth switching circuit SW4 based on a selection signal Ss from the selection line 20.

The modulation circuit 52 generates and outputs control signals Sc2, Sc3 for controlling the second switching circuit SW2 and the third switching circuit SW3 based on a pixel signal Sd from the signal line 22.

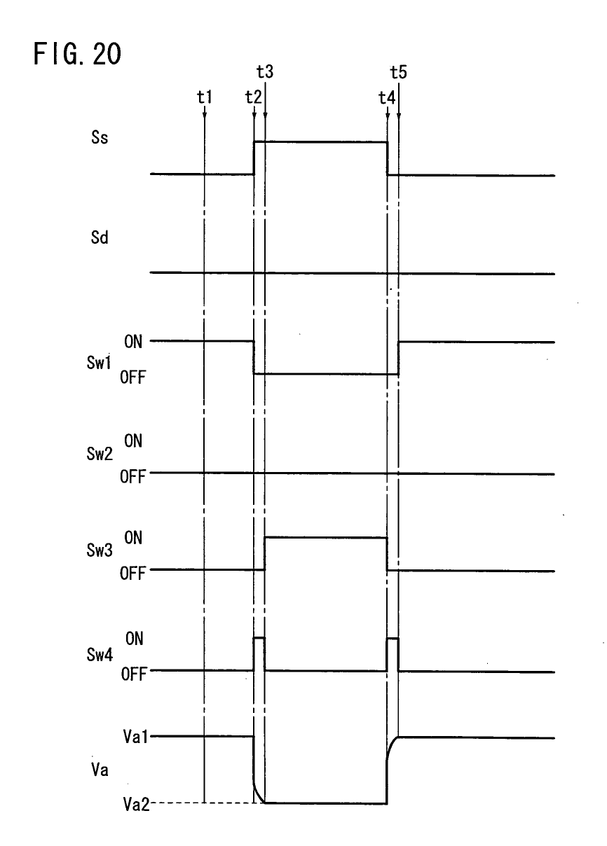

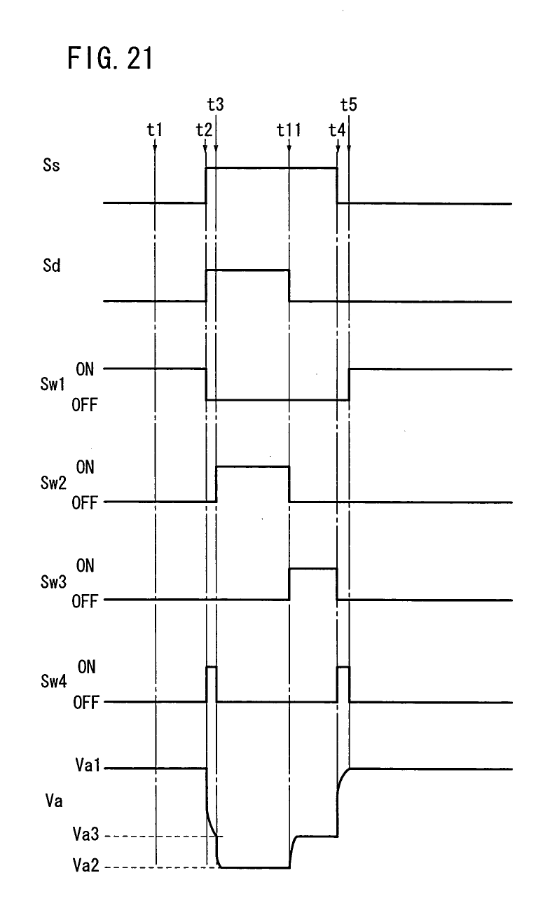

Operation of the drive circuit 26 according to the present embodiment will be described below, with reference to the waveform diagrams shown in FIGS. 20 and 21.

The drive circuit 26 is supplied with a selection signal Ss as shown in FIG. 20, for example, through the selection line 20. The selection signal Ss is normally of a reference level (e.g., 0 V), but is output as a positive pulse in synchronism with a period (selection period Ts) in which an instruction is given to select a row including the pixel. That is, the selection signal Ss has a signal waveform including a positive pulse in the selection period Ts and a reference level in the non-selection period Tu. For illustrative purpose, operation of the drive circuit 26, from a state in which the voltage Va1 is developed across the capacitor C, will be described below.

At time t1, the first switching circuit SW1 is turned on, and the voltage across the capacitor C is substantially the same as the voltage Va1 of the positive power supply 64.

At time t2, when the selection period Ts starts, the first switching circuit SW1 is turned off and the fourth switching circuit SW4 is turned on by the drive voltage generating circuit 50. The inductor 70 and the capacitor C start oscillating sinusoidally, whereupon the voltage across the capacitor C starts being attenuated resonantly. At this time, part of electric charges stored in the capacitor C is retrieved by the buffer capacitor Cf.

If the pixel signal Sd from the signal line 22 is a signal for extinguishing light, then, as shown in FIG. 20, at time t3, i.e., at the time when the oscillating waveform is of the lowest level (voltage: Va=Va2), the fourth switching circuit SW4 is turned off by the drive voltage generating circuit 50, and the third switching circuit SW3 is turned on by the modulation circuit 52. From time t3 onward, the voltage Va2 is maintained until time t4 when the selection period Ts ends.

Thereafter, at time t4 when the selection period Ts ends, the third switching circuit SW3 is turned off by the modulation circuit 52 and the fourth switching circuit SW4 is turned on by the drive voltage generating circuit 50. The inductor 70 and the capacitor C start oscillating sinusoidally, whereupon the voltage across the capacitor C starts being amplified resonantly. At this time, part of electric charges stored in the buffer capacitor Cf is charged in the capacitor C.

At time t5, i.e., at the time when the oscillating waveform is of the highest level (voltage: Va1), the fourth switching circuit SW is turned off and the first switching circuit SW1 is turned on by the drive voltage generating circuit 50. From time t5 onward, the voltage Va1 is maintained until time t2 when the selection period Ts starts.

If the pixel signal Sd from the signal line 22 is a signal for emitting light, then, as shown in FIG. 21, at time t3, i.e., at the time when the oscillating waveform is of the lowest level (voltage: Va=Va3), the fourth switching circuit SW is turned off by the drive voltage generating circuit 50, and the third switching circuit SW3 is turned on by the modulation circuit 52. The voltage across the capacitor C becomes substantially the same as the voltage Va2 of the negative power supply 66. From time t3 onward, the voltage Va2 is maintained up to the pulse duration depending on the gradation component contained in the pixel signal Sd.

The modulation circuit 52 counts clock pulses, for example, for a period of time depending on the pulse duration of the pixel signal Sd. When the counting of clock pulses is completed, i.e., at time t11 when the pulse duration depending on the gradation component contained in the pixel signal Sd elapses, the second switching circuit SW2 is turned off and the third switching circuit SW3 is turned on by the modulation circuit 52. From time t11 onward, the voltage Va3 is maintained until time t4 when the selection period Ts ends. From time t4 onward, the drive circuit 26 operates as described above.

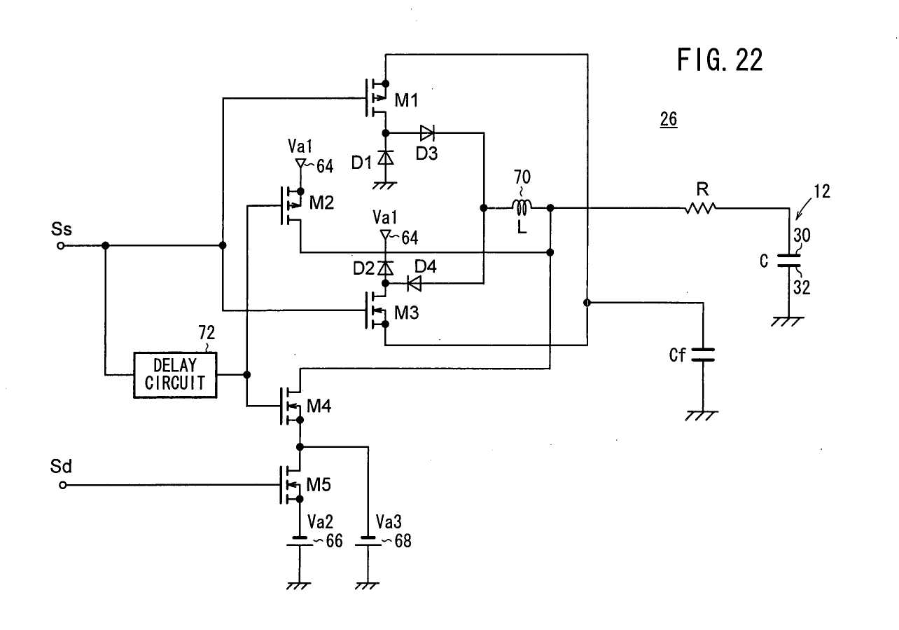

A specific example of the drive circuit 26 will be described below with reference to FIG. 22.

As shown in FIG. 22, the drive circuit 26 according to the specific example has two p-channel thin-film transistors (first and second power pTFTs M1, M2) having a large channel width, three n-channel thin-film transistors (first through third power nTFTs M3 through M5) having a large channel width, four current-controlling diodes (first through fourth diodes D1 through D4), an inductor 70, and a current-suppressing resistor R.

The first power pTFT M1 and the first power nTFT M3 have respective sources connected to each other, and the buffer capacitor Cf has one electrode connected at a junction between these sources.

The first power pTFT M1 has a drain connected to ground through the first diode D1 oriented in a reverse direction, and the first power nTFT M3 has a drain connected to the positive power supply 64 (voltage Va1) through the second diode D2 oriented in a reverse direction. The third and fourth diodes D3, D4 are connected in series in a forward direction between the drain of the first power pTFT M1 and the drain of the first power nTFT M3.

The inductor 70 and the resistor R are connected in series between the junction between the third and fourth diodes D3, D4 and the cathode electrode 30 of the capacitor C.

The second power pTFT M2 and the second power nTFT M4 have respective drains connected to each other, and also connected to the junction between the inductor 70 and the resistor R.

The second power nTFT M4 has a source connected to the drain of the third power nTFT M5, and the junction between them is connected to ground through the negative power supply 68 (voltage Va3). The third power nTFT M5 has a source connected to ground through the negative power supply 66 (voltage Va2).

The first power pTFT M1 and the first power nTFT M3 have respective gates supplied with the selection signal Ss from the selection line 20, and the second power pTFT M2 and the second power nTFT M4 have respective gates supplied with the selection signal Ss from the selection line 20 through a delay circuit 72. The delay circuit 72 has a delay time set to T/4, where T represents the resonant period of the inductor 70 and the capacitor C.

The third power nTFT M5 has a gate supplied with the pixel signal Sd from the signal line 22. In this example, the pulse duration 1a of the pixel signal Sd becomes directly the pulse duration τ2 of the second amplitude V2.

Operation of the drive circuit 26 according to the specific example will be described below with reference to FIGS. 20 and 21. At time t1, i.e., at the time when the selection signal Ss is of the reference level and the second power pTFT M2 is turned on, the voltage across the capacitor C is substantially the same as the voltage Va1 of the positive power supply 64 which is connected to the source of the second power pTFT M2.

When the selection signal Ss goes high at time t2 and the selection period Ts starts, the first power pTFT M1 is turned off and the first power nTFT M3 is turned on. Therefore, the capacitor C and the buffer capacitor Cf are connected to each other through the resistor R, the inductor 70, the fourth diode D4, and the drain and source of the first power nTFT M3. The inductor 70 and the capacitor C now start oscillating sinusoidally, whereupon the voltage across the capacitor C starts being attenuated resonantly. At this time, part of electric charges stored in the capacitor C is retrieved by the buffer capacitor Cf.

Next, at time t3, i.e., when T/4 has elapsed from time t2 when the selection period Ts starts (the time when the oscillating waveform is at its lowest level (voltage: Va=Va2)), the second power nTFT M4 is turned on. At this time, as shown in FIG. 20, if the pixel signal Sd from the signal line 22 is a signal representing the emission of light, the third power nTFT M5 remains turned off. As a result, the capacitor C and the negative power supply 68 are connected to each other through the resistor R and the drain and source of the second power nTFT M4. From time t3 onward, the voltage Va3 is maintained until time t4 when the selection period Ts ends.

Thereafter, at time t4 when the selection period Ts ends, the selection signal Ss returns to the reference level. Since the first power nTFT M3 is turned off and the first power pTFT M1 is turned on, the buffer capacitor Cf and the capacitor C are connected to each other through the source and drain of the first power pTFT M1, the third diode D3, the inductor 70, and the resistor R. The inductor 70 and the capacitor C now start oscillating sinusoidally, whereupon the voltage across the capacitor C starts being attenuated resonantly. At this time, part of electric charges stored in the buffer capacitor Cf is retrieved by the capacitor C.

Next, at time t5, i.e., when T/4 has elapsed from time t4 when the selection period Ts ends (the time when the oscillating waveform is of the highest level (voltage: Va1)), the second power pTFT M2 is turned on. As a consequence, the positive power supply 64 and the capacitor C are connected to each other through the source and drain of the second power pTFT M2 and the resistor R. From time t5 onward, the voltage Va1 is maintained until time t2 when the selection period Ts starts.

If the pixel signal Sd from the signal line 22 is a signal for emitting light, then, as shown in FIG. 21, the third power nTFT M5 is turned on at time t2, and the second power nTFT M4 is also turned on at time t3. Therefore, the capacitor C and the negative power supply 66 are connected to each other through the resistor R, the drain and source of the second power nTFT M4, and the drain and source of the third power nTFT M5. From time t3 onward until time t11 when the pixel signal Sd returns to the reference level, the voltage Va2 is maintained over the pulse duration Ta of the pixel signal Sd.

At time t11 when the pulse duration Ta of the pixel signal Sd elapses, since the pixel signal Sd returns to the reference level, the third power nTFT M5 is turned off. From time t11 onward, the voltage Va3 is maintained until time t4 when the selection period Ts ends. From time t4 onward, the drive circuit 26 operates as described above.

An experimental example conducted with respect to the drive circuit 26 according to the specific example shown in FIG. 22, i.e., an experimental example concerning the electric power retrieval ratio, will be described below.

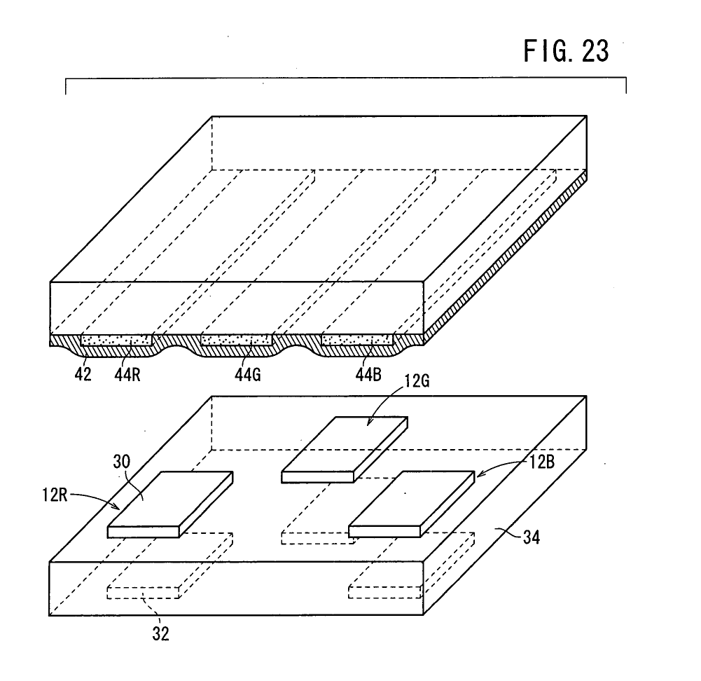

As shown in FIG. 23, a single emitter 34 was associated with three sets of cathode electrodes 30 and anode electrodes 32, providing three electron emitters (first through third electron emitters 12R, 12G, 12B). As shown in FIG. 23, the first through third electron emitters 12R, 12G, 12B were staggered with respect to each other. A red phosphor 44R was disposed above the first electron emitter 12R, a green phosphor 44G was disposed above the second electron emitter 12G, and a blue phosphor 44B was disposed above the third electron emitter 12B, for displaying color images.

Drive circuits 26 according to the specific examples were connected respectively to the first through third electron emitters 12R, 12G, 12B, with only one buffer capacitor Cf connected thereto. For simpler interconnections, one selection line 20 and one signal line 22 were connected in common to the drive circuits 26.

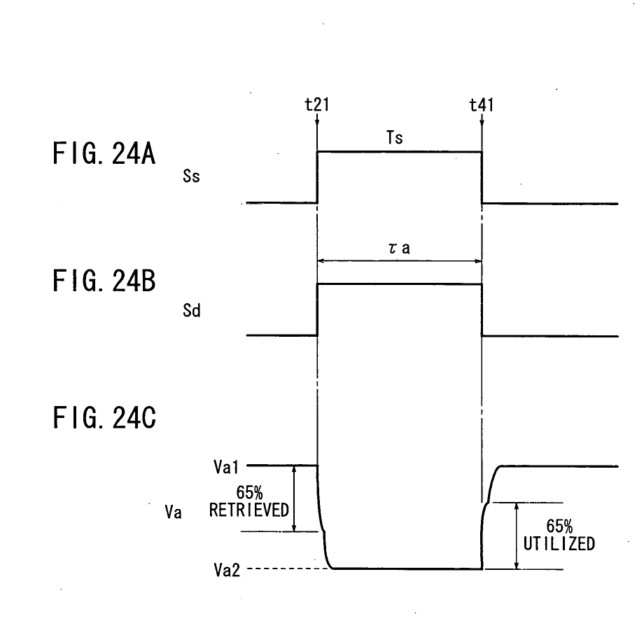

In the present experimental example, for measuring an electric power retrieval ratio, as shown in FIGS. 24A and 24B, the waveforms were simplified such that the voltage Va1 (the voltage of the positive power supply 64) applied to the electron emitters 12R, 12G, 12B was 135 V and the voltage Va2 (the voltage of the positive power supply 66) applied thereto was 0 V. The pulse duration (selection period Ts) of the selection signal Ss was the same as the pulse duration τa of the pixel signal Sd.

As a result, as shown in FIG. 24C, at time t21 when the selection period Ts starts, 87.3 V was retrieved from each of the first through third electron emitters 12R, 12G, 12B, and at time t41 when the selection period Ts ends, 87.3 V was utilized for each of the first through third electron emitters 12R, 12G, 12B. Thus, the electric power retrieval ratio was 87.3 V/135 V=65%.

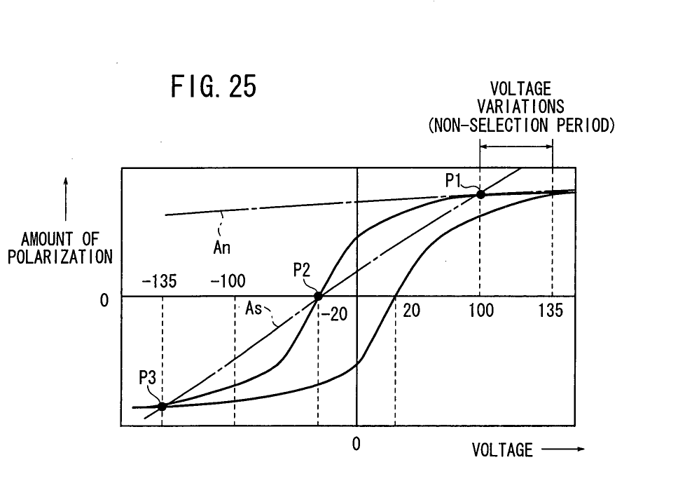

A preferred drive process (first drive process), for the case where the emitter 34 is made of a piezoelectric material, and another preferred drive process (second drive process), for the case where the emitter 34 is made of an electrostrictive material, will be described below with reference to FIGS. 25 through 28.

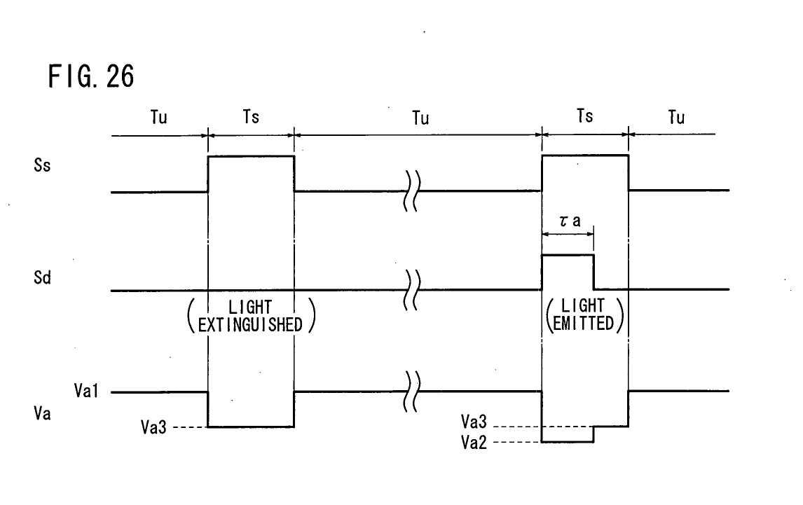

The first drive process will be described below with reference to FIGS. 25 and 26. As shown in FIG. 25, the piezoelectric material of the emitter 34 has a polarization vs. electric field characteristic curve, which exhibits a hysteresis curve based on an electric field E=0 (V/mm).

In a curve segment from point p1 through point p2 to point p3 on the hysteresis curve, the piezoelectric material is polarized almost in one direction at the point P1 where the electric field is applied having positive polarity. Thereafter, the electric field is applied with a negative polarity, and when it exceeds point p2 of the coercive voltage (about −20 V), the polarization starts to be inverted. The polarization becomes fully inverted at point p3.

Therefore, according to the first drive process, as shown in FIG. 26, during the non-selection period Tu, the voltage Va1 (e.g., 100 V) is applied between the cathode electrode 30 and the anode electrode 32, by applying a voltage of positive polarity to the emitter 34. At this time, as can be seen from the polarization vs. electric field characteristic curve shown in FIG. 25, the emitter 34 is polarized in one direction.

Thereafter, during the selection period Ts shown in FIG. 26, if the pixel signal Sd is a signal representing the extinguishing of light, then the voltage Va3 (a voltage insufficient to emit electrons from the electron emitter 12, e.g., −100 V) is applied between the cathode electrode 30 and the anode electrode 32. At this time, no electrons are emitted from the electron emitter 12.

On the other hand, during the selection period Ts as shown in FIG. 26, if the pixel signal Sd is a signal representing the emission of light, then the voltage Va2 (a voltage sufficient enough to emit electrons from the electron emitter 12, e.g., −135 V) is applied between the cathode electrode 30 and the anode electrode 32, for a period of time corresponding to the pulse duration Ta of the pixel signal Sd. Electrons are now emitted at the point p3 shown in FIG. 25. After elapse of the period of time corresponding to the pulse duration 1a of the pixel signal Sd until the time when the selection period Ts ends, the voltage Va3 (e.g., −100 V) is applied between the cathode electrode 30 and the anode electrode 32.

When the non-selection period Tu begins again, the voltage Va1 is applied between the cathode electrode 30 and the anode electrode 32 to polarize the emitter 34 in one direction. During the non-selection period Tu, pixel signals Sd may be supplied to electron emitters of other rows. With the drive circuit 26 shown in FIG. 22, for example, insofar as the selection signal Ss is maintained at the reference level, the electron emitter 12 is not affected by pixel signals Sd for electron emitters of other rows.

If the drive circuit 26 employs another circuit arrangement, then changes in the voltages Va2, Va3 depending on the pulse duration Ta of the pixel signal Sd could possibly be applied to the electron emitter 12, which is not selected during the non-selection period Tu. Therefore, the voltage Va1 applied during the non-selection period Tu should preferably be of a level such that, even when changes in the voltages Va2, Va3 are added thereto, the amount of polarization of the emitter 34 will not be essentially varied.

According to the characteristic curve shown in FIG. 25, if the level of the voltage Va1 is set at 100 V, in view of changes in the voltages Va2, Va3, then the amount of polarization of the emitter 34 is not essentially varied even when the voltage Va1 changes between 100 V and 135 V, due to pixel signals Sd for electron emitters of other rows.

The total electric power consumption of the electron emitter 12, when the emitter 34 is made of a piezoelectric material, will be described below. The electron emitter 12 is assumed for use in a 40-inch XGA (Extended Graphics Array) color display.

Electric power Ps consumed by a selected electron emitter 12 is expressed by:
Ps=Cs×(Vs)²×fa×n
where Cs represents the capacitance of the selected electron emitter 12 (corresponding to the slope of the dot-and-dash-line curve As shown in FIG. 25), Vs the maximum amplitude of the drive voltage Va applied when the electron emitter 12 is selected, fa the frequency of one frame, and n the number of pixels.

Since Cs=12 pF, Vs=100−(−135)=235 V, fa=60 Hz, and n=1024 (vertical)×768 (horizontal)×3 (colors)=2359296, the consumed electric power Ps is Ps≈93 W.

If the electric power retrieval ratio is 65%, then consumed electric power dPs after electric power retrieval is given as:
dPs=Ps×(1−0.65)=93 W×0.35=32 W

The electric power Pn consumed by a non-selected electron emitter 12 is expressed by:
Pn=Cn×(Vn)²×fa×n×m
where Cn represents the capacitance of the non-selected electron emitter 12 (corresponding to the slope of the dot-and-dash-line curve An in FIG. 25), Vn the maximum amplitude of the drive voltage Va applied when the electron emitter 12 is not selected, fa the frequency of one frame, n the number of pixels, and m the number of non-selected rows.

Since Cn=5 pF, Vn=35 V, fa=60 Hz, n=1024 (vertical)×768 (horizontal)×3 (colors)=2359296, and m=64−1, the consumed electric power Pn is Pn≈55 W. The electric power Pp consumed to excite the phosphor is Pp=96 W.

Therefore, the total electric power Pa that is consumed by the electron emitter 12 is given as:

$$P a = dPs + Pn + Pp \\ = 32 W + 55 W + 96 W \\ = 183 W$$

The total consumed electric power Pa is lower than that of plasma displays or liquid-crystal displays of the same size.

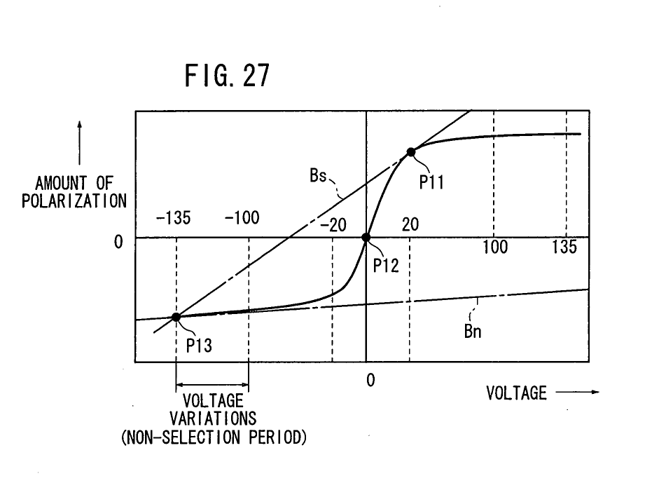

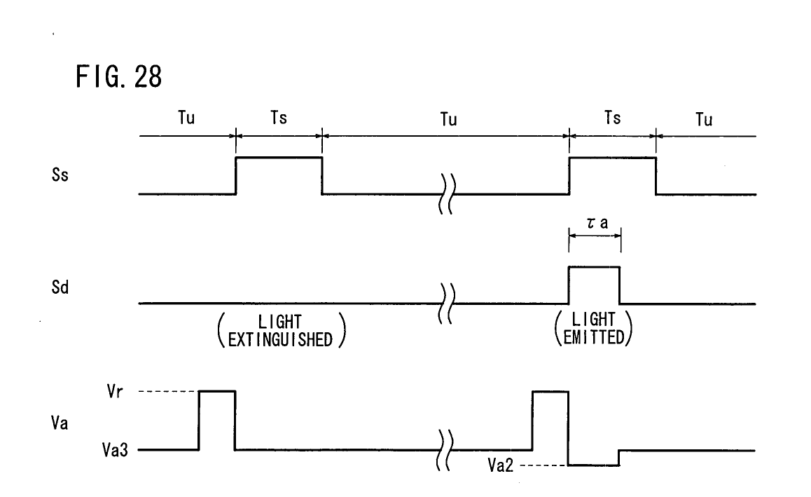

The second drive process will be described below with reference to FIGS. 27 and 28.

As shown in FIG. 27, the polarization vs. electric field characteristic of the electrostrictive material from which the emitter 34 is made is such that the electrostrictive material is polarized substantially proportional to the applied voltage, wherein the rate of change of polarization is greater at lower voltages (absolute value) than at higher voltages. At any rate, it can be seen that the polarization of the emitter 34 occurs diffusely, depending on a change in the applied voltage. When the applied voltage is removed, the polarization is reset.

In a curve segment from point p11 through point p12 to point p13 on the characteristic curve, the electrostrictive material is polarized almost in one direction at point P11, where an electric field is applied having positive polarity. Thereafter, as the applied voltage (absolute value) is lowered, the amount of polarization in one direction is reduced depending on the voltage having positive polarity, and the polarization is reset at point P12 when the applied voltage reaches 0. When a voltage having negative polarity is thereafter applied, the polarization starts to be inverted. The amount of polarization in the other direction increases as the voltage (absolute value) having negative polarity increases, and the electrostrictive material is polarized almost in the other direction at point P13. The emitter 34 is thus polarized depending on the applied voltage.

According to the second drive process, as shown in FIG. 28, during the non-selection period Tu immediately prior to the selection period Ts, a reset voltage Vr (e.g., 50 V) is applied between the cathode electrode 30 and the anode electrode 32, thus applying an electric field of positive polarity to the emitter 34. As can also be seen from the polarization vs. electric field characteristic shown in FIG. 27, the emitter 34 is polarized in one direction. The voltage Vr may be set to the reference voltage (0 V), so as not to apply an electric field to the emitter 34 immediately prior to the selection period Ts. At this time, as can also be seen from the polarization vs. electric field characteristic, the emitter 34 is in a non-polarized state.

Thereafter, during the selection period Ts, if the pixel signal Sd is a signal representing the extinguishing of light, then the voltage Va3 (e.g., −100 V) is applied between the cathode electrode 30 and the anode electrode 32. At this time, no electrons are emitted from the electron emitter 12.

During the selection period Ts, as shown in FIG. 28, if the pixel signal Sd is a signal representing the emission of light, then the voltage Va2 (e.g., −135 V) is applied between the cathode electrode 30 and the anode electrode 32, for a period of time corresponding to the pulse duration 1a of the pixel signal Sd, causing a large polarization change in the emitter 34. Electrons are now emitted at point p13.

When the non-selection period Tu begins, in this example, the voltage Va3 (e.g., −100 V) is applied between the cathode electrode 30 and the anode electrode 32. During the non-selection period Tu, any arbitrary voltage between the reset voltage Vr and the voltage Va2 may be applied. Since the voltage is not a sharp voltage change immediately after the reset voltage Vr, no electrons are emitted from the electron emitter 12. Specifically, within the selection period Ts, if the pixel signal Sd is a signal representing the emission of light, since the emitter 34 is sufficiently polarized in one direction immediately prior to the selection period (the period during which the reset voltage Vr is applied), electrons are emitted when the selection period Ts begins. However, even if an arbitrary voltage as described above is applied during the non-selection period Tu after elapse of the selection period Ts, because part of the emitter 34 has not been sufficiently polarized in one direction, no electrons are emitted.

During the non-selection period Tu immediately prior to the selection period Ts, the reset voltage Vr is applied to polarize part of the emitter 34 again in one direction. Therefore, the period during which the reset voltage Vr is applied may be defined as a preparatory period for preparing the emitter 34 to emit electrons at the next selection period Ts.

During the non-selection period Tu, since a pixel signal Sd is supplied to electron emitters of other rows, depending on the circuit arrangement of the drive circuit 26, changes in the voltages Va2, Va3 depending on the pulse duration τa of the pixel signal Sd could possibly be applied to the non-selected electron emitter 12.

According to the characteristic curve shown in FIG. 27, if the level of the voltage Va1 is set to 100 V, in view of changes in the voltages Va2, Va3, then the amount of polarization of the emitter 34 is not essentially varied, even if the voltage Va3 changes between −100 V and −135 V due to pixel signals Sd for electron emitters of other rows.

The total electric power consumption by the electron emitter 12, when the emitter 34 is made of an electrostrictive material, will be described below.

The electric power Ps consumed by the selected electron emitter 12 is expressed by:
PS=Cs×(Vs)²×fa×n
where Cs represents the capacitance of the selected electron emitter 12 (corresponding to the slope of the dot-and-dash-line curve Bs shown in FIG. 27), Vs the maximum amplitude of the drive voltage Va applied when the electron emitter 12 is selected, fa the frequency of one frame, and n the number of pixels.

Since Cs=10 pF, Vs=50−(−135)=185 V, fa=60 Hz, and n=1024 (vertical)×768 (horizontal)×3 (colors)=2359296, the consumed electric power Ps is Ps≈48 W.

If the electric power retrieval ratio is 65%, then the consumed electric power dPs after electric power retrieval is given as:
dPs=Ps×(1−0.65)=48 W×0.35=17 W

The electric power Pn consumed by the non-selected electron emitter 12 is expressed by:
Pn=Cn×(Vn)²×fa×n×m
where Cn represents the capacitance of the non-selected electron emitter 12 (corresponding to the slope of the dot-and-dash-line curve Bn in FIG. 27), Vn the maximum amplitude of the drive voltage Va applied when the electron emitter 12 is not selected, fa the frequency of one frame, n the number of pixels, and m the number of non-selected rows.

Since Cn=5 pF, Vn=35 V, fa=60 Hz, n=1024 (vertical)×768 (horizontal)×3 (colors)=2359296, and m=64−1, the consumed electric power Pn is Pn≈35 W. The electric power Pp consumed to excite the phosphor is Pp=96 W.

Therefore, the total electric power Pa consumed by the electron emitter 12 is given as:

$$P a = dPs + Pn + Pp \\ = 17 W + 55 W + 96 W \\ = 168 W$$

The total consumed electric power Pa is lower than according to the first drive process.

According to the second drive process, the thickness d of the emitter 34 may be reduced for driving the electron emitter 12 at a lower drive voltage.

The electric power Ps consumed when the electron emitter 12 is selected, the electric power Pn consumed when the electron emitter 12 is not selected, and the electric power Pp consumed to excite the phosphor, which are taken into account to determine the total consumed electric power Pa, will be reviewed below. The electric power Ps consumed when the electron emitter 12 is selected is sufficiently lowered by electric power retrieval. The electric power Pp consumed to excite the phosphor is inevitable and cannot easily be controlled. Therefore, the electric power Pn consumed when the electron emitter 12 is not selected should be reduced, for effectively lowering the total consumed electric power Pa. One proposal is to improve the characteristics of the electrostrictive material. By improving the characteristics of the electrostrictive material, as shown in FIG. 27, the slope of the dot-and-dash-line curve Bn, which determines the capacitance when the electron emitter 12 is not selected, may be reduced substantially to zero (i.e., made substantially flat) for further reducing the electrostatic capacitance C when the electron emitter 12 is not selected, and thereby effectively reducing the electric power Pn consumed when the electron emitter 12 is not selected.

Even if the emitter 34 is made of an electrostrictive material, the first drive process described above may be employed, to apply a voltage of positive polarity (e.g., +100 V through +135 V) during the non-selection period. In this case, no reset voltage is required.

With the display 10A according to the first embodiment and the drive process therefor, based on an instruction from a corresponding selection line 20, a drive voltage Va applied between the cathode electrode 30 and the anode electrode 32 of a corresponding electron emitter 12 is generated. The amplitude of the drive pulse Pd is modulated stepwise based on a pixel signal Sd from a corresponding signal line 22, thereby controlling the luminance gradation of a corresponding pixel. Therefore, the amount of electrons emitted from the electron emitter 12 can be controlled in an analog fashion for fine gradation control.

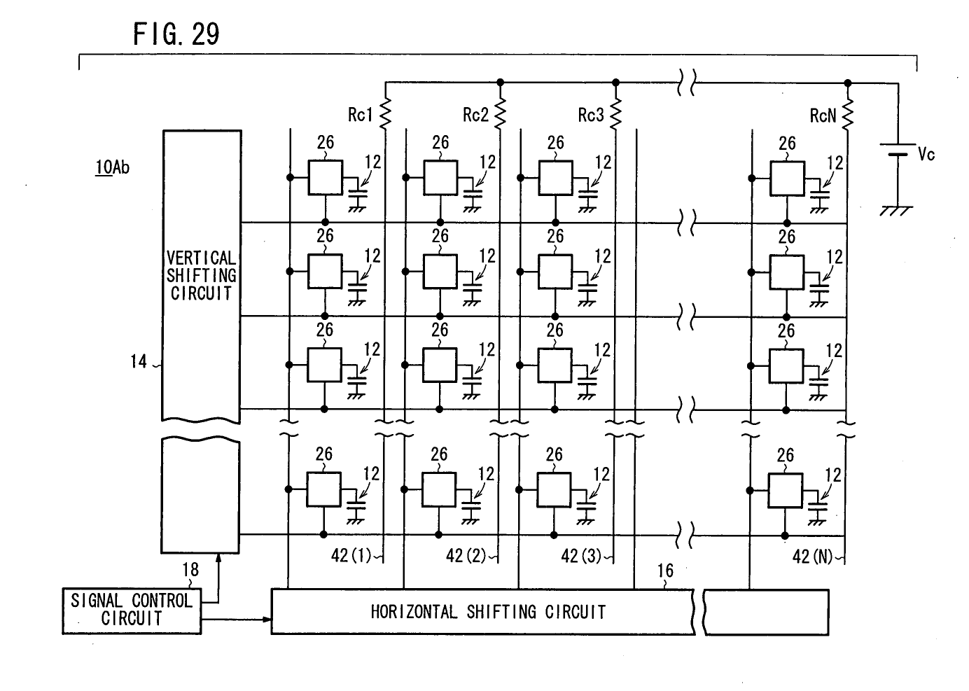

As shown in FIG. 1, the display 10A according to the first embodiment has one collector electrode 42 associated with a plurality of electron emitters 12, and a bias voltage Vc is applied to the collector electrode 42 through the resistor R2. However, in a display 20Ab according to a second modification, as shown in FIG. 29, as many collector electrodes 42(1), 42(2), . . . , 42(N) as the number of columns of the display 20Ab, and resistors Rc1, Rc2, . . . , RcN, are connected respectively to the collector electrodes 42(1), 42(2), . . . , 42(N). With this arrangement, variations introduced during the manufacturing process, e.g., luminance variations of the electron emitters 12, may be adjusted by the resistors Rc1, Rc2, . . . , RcN that are connected respectively to the collector electrodes 42(1), 42(2), 42(N).

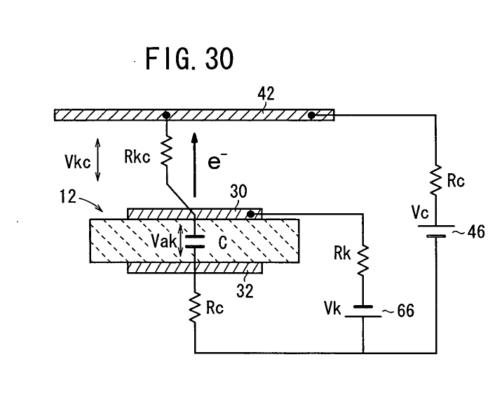

Adjustment of such luminance variations will be described below with reference to FIGS. 30 through 33.

According to a conventional process of lowering such variations, as described in the literature, “Electronic Technology 2000-7, pp. 38-41: Latest Technology Trends of Field Emission Displays,” for example, current-suppressing resistors are connected to the emitters for lowering variations.

The conventional process is based on the relationship between the current flowing through the emitter and the gate voltage, and requires a number of simulations to be performed until optimum resistances for lowering luminance variations are obtained.

According to the present embodiment, a process is employed for adjusting the electric field between the collector electrode 42, which is actually reached by emitted electrons, and the cathode electrode 30, so as to directly adjust luminance variations and lower such luminance variations quickly and accurately.

The process of lowering luminance variations according to the present embodiment shall be described in detail below. As shown in FIG. 30, a resistor Rk is connected between the cathode electrode 30 and the negative power supply 66, which applies a negative voltage Vk (e.g., a voltage which is the same as the voltage Va2 described above) between the cathode electrode 30 and the anode electrode 32, and a resistor Rc is connected between the collector electrode 42 and the bias power supply 46 (bias voltage Vc), wherein the values of the resistors Rk and Rc may be adjusted. In FIG. 30, Rkc represents a resistance across the gap between the cathode electrode 30 and the collector electrode 42, Vkc a voltage across the gap, C a capacitance between the cathode electrode 30 and the anode electrode 32, and Vak a voltage between the cathode electrode 30 and the anode electrode 32.

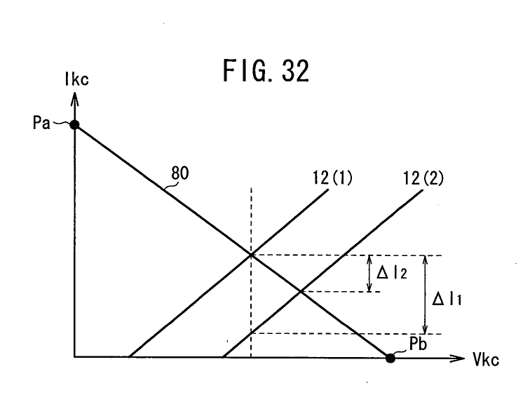

Assuming that there are two electron emitters 12(1), 12(2), when the electron emitters 12(1), 12(2) have different output characteristics (Vkc vs. Ikc characteristics), as shown in FIG. 32, in the absence of resistors Rk and Rc, a current change in the electron emitters 12(1), 12(2) is represented by ΔI₁.

By connecting resistors Rk and Rc, the current change ΔI₁ can be reduced to a lower current change ΔI₂ on a load line 80.

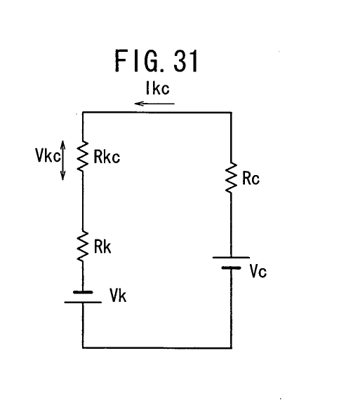

The load line 80 can be represented as follows: Based on the structure shown in FIG. 30, an equivalent circuit based primarily on a current Ikc flowing between the cathode electrode 30 and the collector electrode 42 can be plotted as shown in FIG. 31.

From the equivalent circuit, the following equation is derived:
Ikc=(Vk+Vc)/(Rc+Rkc+Rk)

Since the current Ikc is maximum when Rkc=0, as shown in FIG. 32, the load line 80 is drawn as a line interconnecting a point Pa on the vertical axis, which represents Ikc=(Vk+Vc)/(Rc+Rk), and a point Pb on the horizontal axis, which represents Vkc=Vk+Vc.

As Rc+Rk becomes greater, the current Ikc becomes smaller, reducing luminance variations between the electron emitters 12(1), 12(2).

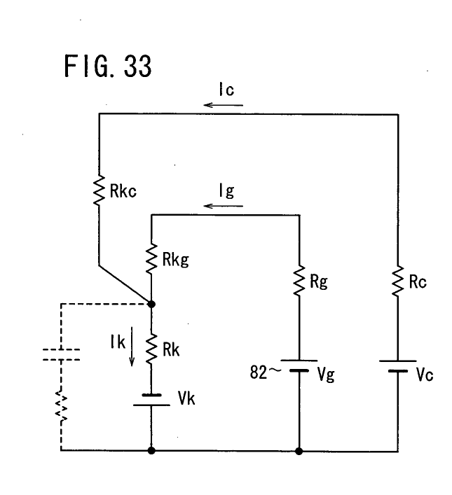

If a control electrode (not shown) is connected between the cathode electrode 30 and the collector electrode 42, then an equivalent circuit, based primiarly on the collector current Ic flowing through the collector electrode and the control current Ig flowing through the control electrode, can be plotted as shown in FIG. 33. A resistor Rg is connected between the control electrode and a negative power supply 82, which applies a negative voltage Vg between the control electrode and the anode electrode 32. In FIG. 33, Rkg represents the resistance across the gap between the cathode electrode 30 and the control electrode. The collector current Ic is 60% of the cathode current Ik, and the control current Ig is 40% of the cathode current Ik.

From the equivalent circuit, the following equation is derived:
Ig=(Vg+Vk)/(Rg+Rkg+Rk)

Based on the above equation, a load line 80 is drawn, and the voltage Vg and the resistor Rg for minimizing luminance variations can be determined. With the voltage Vg and the resistor Rg thus determined, the control current Ig and the cathode current Ik can be determined, along with the collector current Ic by necessity.

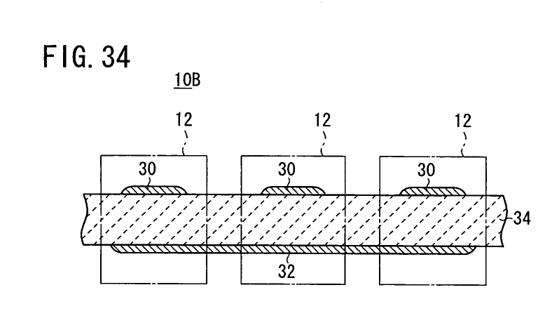

As shown in FIG. 1, the display 10A according to the first embodiment has a plurality of independent cathode electrodes 30 disposed on the face side of one emitter 34, and a plurality of anode electrodes 32 disposed independently on the reverse side of the emitter 34, thus providing a plurality of electron emitters 12. Other embodiments will be described below with reference to FIGS. 34 through 38. For simplifying explanation, in FIGS. 34 through 38, the collector 42 and the phosphors 44 are omitted from illustration.

FIG. 34 shows a display 10B according to a second embodiment of the present invention. The display 10B has a plurality of independent cathode electrodes 30 disposed on the face side of one emitter 34, and a single anode 32 (common anode electrode) disposed on the reverse side of the emitter 34, thus providing a plurality of electron emitters 12.

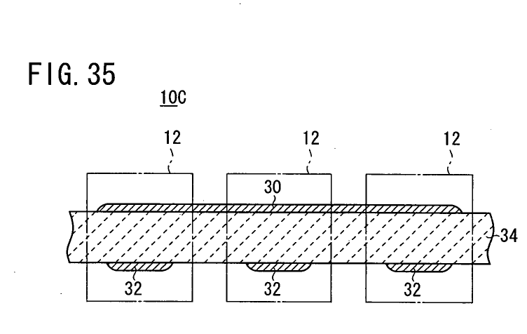

FIG. 35 shows a display 10C according to a third embodiment of the present invention. The display 10C has a single very thin cathode electrode 30 (common cathode electrode) having a thickness up to 10 nm, disposed on the face side of one emitter 34, and a plurality of independent anode electrodes 32 disposed on the reverse side of the emitter 34, thus providing a plurality of electron emitters 12.

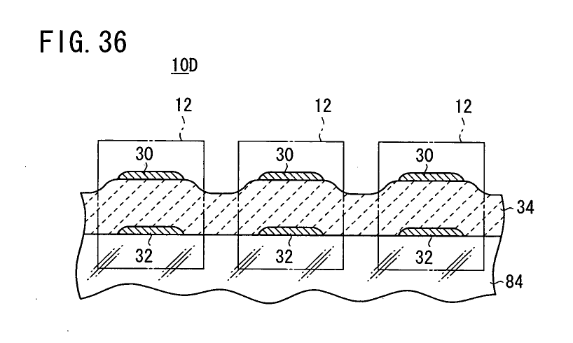

FIG. 36 shows a display 10D according to a fourth embodiment of the present invention. The display 10D has a plurality of anode electrodes 32 disposed independently on a substrate 84, a single emitter 34 disposed in covering relation to the anode electrodes 32, and a plurality of independent cathode electrodes 30 disposed on the emitter 34, thus providing a plurality of electron emitters 12. The cathode electrodes 30 are positioned above the corresponding anode electrodes 32, with the emitter 34 sandwiched therebetween.

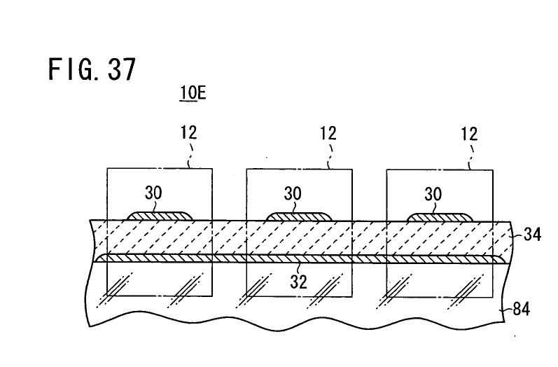

FIG. 37 shows a display 10E according to a fifth embodiment of the present invention. The display 10E has a single anode electrode 32 disposed on a substrate 84, a single emitter 34 disposed in covering relation to the anode electrode 32, and a plurality of independent cathode electrodes 30 disposed on the emitter 34, thus providing a plurality of electron emitters 12.

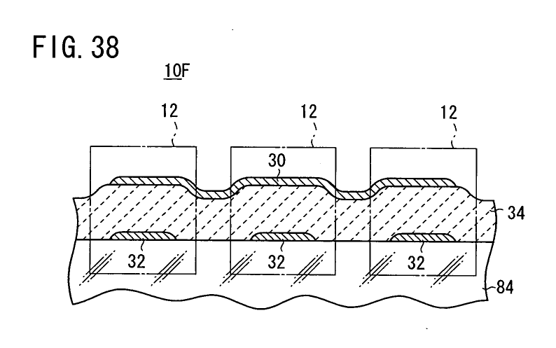

FIG. 38 shows a display 10F according to a sixth embodiment of the present invention. The display 10F has a plurality of anode electrodes 32 disposed independently on a substrate 84, a single emitter 34 disposed in covering relation to the anode electrodes 32, and a single very thin cathode electrode 30 disposed on the emitter 34, thus providing a plurality of electron emitters 12.

The displays 10A through 10F, according to the first through sixth embodiments, offer the following advantages:

(1) The displays can be thinner (having a panel thickness of only several mm) than conventional CRTs.

(2) Since the displays emit natural light from the phosphors 44, they can provide a wide angle of view, of about 1800, unlike conventional LCDs (liquid crystal displays) and LEDs (light-emitting diodes).

(3) Since the displays employ a surface electron source, they produce less image distortions than conventional CRTs.

(4) The displays can respond more quickly than conventional LCDs, and therefore can display moving images that are free of after image effects, with a high-speed response on the order of μsec.

(5) The displays consume electric power less than 200 W for a 40-inch size display, and hence are characterized by lower power consumption than conventional CRTs, PDPs (plasma displays), LCDs and LEDs.

(6) The displays have a wider operating temperature range (−40 to +85° C.) than PDPs or LCDs. LCDs also have lower response speeds at lower temperatures.

(7) The displays can produce higher luminance than conventional FED displays, since the fluorescent material can be excited by a large current output.

(8) The displays can be driven at lower voltages than conventional FED displays, because the drive voltage is controllable by polarization inverting characteristics (or polarization changing characteristics), as well as by the film thickness of the piezoelectric material.

Owing to the various advantages described above, the displays can be used in a variety of applications, as described below.

(1) Since the displays can produce higher luminance and consume lower electric power, they are optimum for use as 30-inch to 60-inch displays, for both home use (television and home theaters) and public use (waiting rooms, karaoke rooms, etc.).

(2) Inasmuch as the displays can produce higher luminance, provide large screen sizes, and can display full-color and high-definition images, they are highly effective in attracting visual attention of consumers, and hence are optimum for use as horizontal, vertically long, or specially shaped displays, as well as displays for exhibitions and message boards for providing guidance and information.

(3) Because the displays can provide a wider angle of view due to higher luminance and fluorescent excitation, and can be operated within a wider operating temperature range due to vacuum modularization, they are optimum for use as displays in vehicles. Displays for use in vehicles typically need to have an 8-inch horizontal size, wherein the horizontal and vertical lengths have a ratio of 15:9 (pixel pitch=0.14 mm), an operating temperature in a range from −30 to +85° C., and a luminance level ranging from 500 to 600 cd/M² in an oblique direction.

As a result of these various advantages, the displays can be used for a variety of light sources, as described below.

(1) Since the displays can produce higher luminance and consume lower electric power, they are optimum for use as projector light sources, which are required to have a luminance level of 2000 lumens.

(2) Because the displays can easily provide a high-luminance two-dimensional array light source, and can be operated in a wide temperature range with light emission that is substantially unchanged in outdoor environments, they are promising as an alternative to LEDs. For example, the displays are optimum for use as an alternative to two-dimensional array LED modules for traffic signal devices. At 25° C. or higher, the allowable current for LEDs is lowered, producing lower luminance.

The display and method of driving the display according to the present invention are not limited to the above embodiments, but may be embodied in various other arrangements without departing from the scope of the present invention.

Although certain preferred embodiments of the present invention have been shown and described in detail, it should be understood that various changes and modifications may be made therein without departing from the scope of the appended claims.

1. A display comprising:
a plurality of electron emitters arrayed in association with respective pixels;
at least one selection line for supplying an instruction to select or not select each of said electron emitters;
at least one signal line for supplying a pixel signal to a selected one of said electron emitters; and
a drive section having a plurality of drive circuits arrayed in association with said electron emitters, respectively, for driving electron emitters based on the instruction from one of said at least one selection line and the pixel signal from one of said at least one signal line;
each of said electron emitters comprising:
an emitter made of a dielectric material; and
a first electrode and a second electrode mounted on said emitter;
each of said drive circuits comprising:
a drive voltage generating circuit for generating a drive voltage to be applied between said first electrode and said second electrode of a corresponding one of the electron emitters based on the instruction from a corresponding one of said at least one selection line; and
a modulation circuit for modulating the amplitude of a drive pulse stepwise based on the pixel signal from a corresponding one of said at least one signal line for thereby controlling the luminance gradation of a corresponding pixel, if said drive voltage has a waveform including said drive pulse appearing in timed relation to the instruction from said selection line and the drive pulse having a predetermined amplitude level is applied between said first electrode and said second electrode to cause at least part of said emitter to invert or change the polarization thereof to emit electrons from said electron emitter.

2. A display according to claim 1, further comprising:
a collector electrode disposed in facing relation to said electron emitters; and
a plurality of fluorescent layers spaced from said electron emitters by respective intervals.

3. A display according to claim 1, wherein the electrons are emitted from the emitter near said first electrode, and said first electrode has a potential lower than the potential of said second electrode during a period in which said drive pulse is applied.

4. A display according to claim 1, wherein said drive voltage generated by said drive voltage generating circuit has a waveform including a drive pulse having a first amplitude which is not sufficient enough to emit electrons from said electron emitter in timed relation to the instruction from said selection line, and said modulation circuit maintains the amplitude of said drive pulse as said first amplitude if said pixel signal is a signal representing the extinguishing of light, and sets the amplitude of said drive pulse to a second amplitude which is sufficient enough to emit electrons from said electron emitter and modulates the pulse duration of said second amplitude based on a gradation component included in said pixel signal if said pixel signal is a signal representing the emission of light.

5. A display according to claim 4, wherein the following relationship is satisfied:
τd=τ1+τ2

|V2|>|V1|

where τd represents the pulse duration of said drive pulse, V1 said first amplitude of said drive pulse, V2 said second amplitude of said drive pulse, τ1 the pulse duration of said first amplitude, and τ2 the pulse duration of said second amplitude.

6. A display according to claim 1, wherein said modulation circuit modulates the amplitude of said drive pulse into a first amplitude which is not sufficient enough to emit electrons from said electron emitter if said pixel signal is a signal representing the extinguishing of light, and sets the amplitude of said drive pulse to a second amplitude which is sufficient enough to emit electrons from said electron emitter and modulates the pulse duration of said second amplitude based on a gradation component included in said pixel signal if said pixel signal is a signal representing the emission of light.

7. A display according to claim 6, wherein the following relationship is satisfied:
τd=τ1+τ2

|V2|>|V1|

where τd represents the pulse duration of said drive pulse, V1 said first amplitude of said drive pulse, V2 said second amplitude of said drive pulse, τ1 the pulse duration of said first amplitude, and τ2 the pulse duration of said second amplitude.

8. A display according to claim 1, wherein said emitter is made of a piezoelectric material or an electrostrictive material, and if the period of one frame includes a selection period and a non-selection period, then at least one said drive pulse is applied between said first electrode and said second electrode in said selection period, and a voltage such that said first electrode has a potential higher than the potential of said second electrode is applied between said first electrode and said second electrode in said non-selection period.

9. A display according to claim 8, wherein said emitter is polarized by an electric field in such a direction that the potential of said first electrode is lower than the potential of said second electrode during said selection period, and said emitter is polarized by an electric field in such a direction that the potential of said second electrode is lower than the potential of said first electrode during said non-selection period.

10. A display according to claim 1, wherein said emitter is made of an electrostrictive material, and if said drive voltage is output in a period including a selection period and a non-selection period, then a reset voltage such that said first electrode has a potential higher than the potential of said second electrode is applied between said first electrode and said second electrode immediately before said selection period, at least one said drive pulse is applied between said first electrode and said second electrode in said selection period, and an arbitrary voltage between at least said reset voltage and the voltage of said drive pulse is applied between said first electrode and said second electrode in said non-selection period, and said selection period starts after said reset voltage is applied.

11. A display according to claim 10, wherein said emitter is polarized by an electric field in such a direction that the potential of said first electrode is higher than the potential of said second electrode under said reset voltage.

12. A method of driving a display having:
a plurality of electron emitters arrayed in association with respective pixels;
at least one selection line for supplying an instruction to select or not select each of said electron emitters;
at least one signal line for supplying a pixel signal to a selected one of said electron emitters; and
a drive section having a plurality of drive circuits arrayed in association with said electron emitters, respectively, for driving electron emitters based on the instruction from one of said at least one selection line and the pixel signal from one of said at least one signal line;
each of said electron emitters comprising an emitter made of a dielectric material and a first electrode and a second electrode mounted on said emitter;
said method comprising the steps of:
generating a drive voltage to be applied between said first electrode and said second electrode of a corresponding one of the electron emitters based on the instruction from a corresponding one of said at least one selection line, and
modulating the amplitude of a drive pulse stepwise based on the pixel signal from a corresponding one of said at least one signal line for thereby controlling the luminance gradation of a corresponding pixel, if said drive voltage has a waveform including said drive pulse appearing in timed relation to the instruction from said selection line and the drive pulse having a predetermined amplitude level is applied between said first electrode and said second electrode to cause at least part of said emitter to invert or change the polarization thereof to emit electrons from said electron emitter.

13. A method according to claim 12, wherein said display further has a collector electrode disposed in facing relation to said electron emitters, and a plurality of fluorescent layers spaced from said electron emitters by respective intervals.

14. A method according to claim 12, wherein the electrons are emitted from the emitter near said first electrode, and said first electrode has a potential lower than the potential of said second electrode during a period in which said drive pulse is applied.

15. A method according to claim 12, wherein said drive voltage has a waveform including a drive pulse having a first amplitude which is not sufficient enough to emit electrons from said electron emitter in timed relation to the instruction from said selection line, and the amplitude of said drive pulse is maintained as said first amplitude if said pixel signal is a signal representing the extinguishing of light, and the amplitude of said drive pulse is set to a second amplitude which is sufficient enough to emit electrons from said electron emitter and the pulse duration of said second amplitude is modulated based on a gradation component included in said pixel signal if said pixel signal is a signal representing the emission of light.

16. A method according to claim 15, wherein the following relationship is satisfied:
τd=τ1+τ2

|V2|>|V1|

where τd represents the pulse duration of said drive pulse, V1 said first amplitude of said drive pulse, V2 said second amplitude of said drive pulse, τ1 the pulse duration of said first amplitude, and τ2 the pulse duration of said second amplitude.

17. A method according to claim 12, wherein the amplitude of said drive pulse is modulated into a first amplitude which is not sufficient enough to emit electrons from said electron emitter if said pixel signal is a signal representing the extinguishing of light, and the amplitude of said drive pulse is set to a second amplitude which is sufficient enough to emit electrons from said electron emitter and the pulse duration of said second amplitude is modulated based on a gradation component included in said pixel signal if said pixel signal is a signal representing the emission of light.

18. A method according to claim 17, wherein the following relationship is satisfied:
τd=τ1+τ2

|V2|>|V1|

where τd represents the pulse duration of said drive pulse, V1 said first amplitude of said drive pulse, V2 said second amplitude of said drive pulse, τ1 the pulse duration of said first amplitude, and τ2 the pulse duration of said second amplitude.

19. A method according to claim 12, wherein said emitter is made of a piezoelectric material or an electrostrictive material, and if the period of one frame includes a selection period and a non-selection period, then at least one said drive pulse is applied between said first electrode and said second electrode in said selection period, and a voltage such that said first electrode has a potential higher than the potential of said second electrode is applied between said first electrode and said second electrode in said non-selection period.

20. A method according to claim 19, wherein said emitter is polarized by an electric field in such a direction that the potential of said first electrode is lower than the potential of said second electrode during said selection period, and said emitter is polarized by an electric field in such a direction that the potential of said second electrode is lower than the potential of said first electrode during said non-selection period.

21. A method according to claim 12, wherein said emitter is made of an electrostrictive material, and if said drive voltage is output in a period including a selection period and a non-selection period, then a reset voltage such that said first electrode has a potential higher than the potential of said second electrode is applied between said first electrode and said second electrode immediately before said selection period, at least one said drive pulse is applied between said first electrode and said second electrode in said selection period, and an arbitrary voltage between at least said reset voltage and the voltage of said drive pulse is applied between said first electrode and said second electrode in said non-selection period, and said selection period starts after said reset voltage is applied.

22. A method according to claim 21, wherein said emitter is polarized by an electric field in such a direction that the potential of said first electrode is higher than the potential of said second electrode under said reset voltage.
